(19) United States
(12) Patent Application Publication
(10) Pub. No.: US 2026/0367924 A1
(43) Pub. Date: Nov. 19, 2026

(54) Boot Channel Architecture for Hierarchical Chiplet Initialization

(71) Applicant: Tenstorrent USA, Inc., Austin, TX (US)

(72) Inventors: Zhimin Chen, San Jose, CA (US); Roy Franz, Roseville, CA (US); Lichen Weng, San Jose, CA (US)

(21) Appl. No.: 19/680,303

(22) Filed: May 18, 2026

Related U.S. Application Data
(60) Provisional application No. 63/807,880, filed on May 18, 2025.

(51) Int. Cl. G06F 9/4401; G06F 21/57

(52) U.S. Cl. CPC G06F 9/4403; G06F 21/575; G06F 2221/034

(57) ABSTRACT

Systems and methods related to hierarchical multi-stage boots are disclosed herein. For example, a system-in-package may comprise a first chiplet, a second chiplet, a data-plane channel, and a boot-channel connection. When enabled, the data-plane channel may carry data-plane traffic between the first and second chiplets. The boot-channel connection may, upon supply of power and clock, support communication of boot transactions from the first chiplet to the second chiplet before the data-plane channel is enabled. In specific embodiments, a chiplet may operate as a boot-secondary chiplet with respect to an upstream self-boot chiplet and operate as a self-boot chiplet with respect to a downstream chiplet. In specific embodiments, the boot may include a chiplet boot stage and a system-in-package boot stage. Accordingly, a diverse network of chiplets may have defined responsibilities, inter-chiplet communication interfaces, and software interfaces between different boot stages. The always-available Boot Channel may enable early boot transactions.

### CROSS REFERENCE TO RELATED APPLICATIONS

This application claims the benefit of U.S. Provisional Patent Application No. 63/807,880, filed May 18, 2025, which is incorporated by reference herein in its entirety for all purposes.

### BACKGROUND

The present description relates to a hierarchical multi-stage boot for a network of chiplets. Chiplets are small, specialized integrated circuits designed to function as individual components. Chiplets are then integrated together to form a System in Package (SiP), which behaves like a traditional monolithic silicon chip, especially from high-level software perspective. Unlike traditional monolithic integrated circuits where all functions are manufactured together on a single piece of silicon, chiplets may be designed, fabricated, and assembled separately. This approach allows for greater flexibility, improved yields, higher cost efficiency, and shorter time to market. While a chiplet-based SiP offers appealing advantages, it also brings new challenges to the SiP development, especially interoperability among various chiplets. There is a growing demand to standardize the chiplet interfaces and assure interoperability so that the advantages are indeed redeemed.

Partitioning functions across multiple chiplets can increase the complexity of inter-chiplet communication. A chiplet package may include multiple classes of inter-chiplet communication paths. For example, a package may include one or more higher-bandwidth die-to-die paths for data movement and one or more lower-bandwidth or out-of-band paths for initialization, configuration, management, or other control communications. Different chiplets in the package may support different combinations of bus protocols, transport mechanisms, and physical interface types.

While some chiplets maintain standalone boot solutions, others rely on another chiplet for early boot configuration, firmware/software loading, and boot status reporting. This necessitates alignment among chiplets from different vendors on communication, boot setup, and boot flow. Chiplets may also have different security architectures, with varying definitions of secure boot, security domains, secure lifecycle control, and system/application security support. These differences pose challenges for seamless integration, as misalignment can introduce security vulnerabilities. Additionally, some security applications require complex cross-chiplet collaboration.

Compared to monolithic systems-on-chip (SoCs), the boot process of a SiP may need to account for differences between chiplets. Some chiplets may be not self-sufficient for boot and may instead rely on other chiplets to load their configuration and software. Assets, such as intellectual property and secrets, may be owned by different entities. Die-to-die (D2D) communications may need to be established during the boot process. Coordinating protocol support, transport support, and physical interface compatibility across communicating chiplets can add additional complexity to system design and runtime operation. These complications can make booting more difficult. Accordingly, there is a need for improved chiplet boot techniques.

### SUMMARY

This disclosure relates to hierarchical multi-stage boots in a network of chiplets. Networks of chiplets are more complex than monolithic systems because chiplets may be designed, fabricated, and assembled separately. The increased complexity and involvement of multiple stakeholders require a standardized boot flow to define owner responsibilities, inter-chiplet communication interfaces, and software interfaces between different boot stages.

The present disclosure describes a hierarchical multi-stage boot architecture for a system-in-package (SiP) including multiple chiplets. In the disclosed architecture, boot is not required to be centralized in a single chiplet that directly boots every other chiplet in the package. Instead, boot responsibility may be distributed across a boot topology of chiplets. A boot-primary chiplet may initiate boot of one or more boot-secondary chiplets, and a boot-secondary chiplet that is capable of self-booting may, after completing its own local boot operations, act as an upstream boot agent for one or more downstream chiplets. In this manner, an intermediate chiplet may be a boot-secondary chiplet with respect to an upstream chiplet while also functioning as an upstream self-boot chiplet with respect to a downstream chiplet.

The boot topology may therefore form a hierarchy, such as a tree or directed acyclic graph, in which boot control, boot-image transfer, boot synchronization, and boot-status reporting occur along defined upstream and downstream relationships. For example, a first chiplet may boot or synchronize a second chiplet, and the second chiplet may then boot or synchronize a third chiplet. Boot status from the third chiplet may be reported to the second chiplet and then forwarded or aggregated toward the boot-primary chiplet. This distributed approach allows boot responsibility to be placed closer to the chiplets being initialized and reduces the need for a single centralized boot chiplet to directly manage all chiplets in the system-in-package.

The disclosed boot process may proceed in multiple stages. During a chiplet boot stage, a chiplet may perform local initialization needed to make the chiplet ready for package-level boot. The chiplet boot stage may include, for example, local reset release, clock or power configuration, local fabric configuration, loading or verifying chiplet-stage boot code, setting chiplet-specific configuration, and preparing boot-status or readiness information. This stage may be associated with chiplet-local boot resources and chiplet-level ownership, such as boot code supplied or controlled by a chiplet designer.

After one or more chiplets complete their chiplet boot stages, the system may proceed to a SiP boot stage. During the SiP boot stage, package-level configuration may be performed across multiple chiplets. This stage may include coordinating multiple chiplets, loading SiP-stage boot code, configuring package-level resources, enabling data-plane channels, initializing inter-chiplet communication paths used for ordinary operational traffic, and preparing the SiP for later software execution. The separation between a chiplet boot stage and a SiP boot stage allows chiplet-local initialization to be distinguished from package-level integration and bring-up.

The architecture may also provide a Boot Channel that is available at the beginning of boot. The Boot Channel may be distinct from a data-plane channel that carries ordinary operational traffic between chiplets after the system has been initialized. Upon supply of power and clock to chiplets, the Boot Channel may enter a default operational state that supports boot transactions before the data plane is enabled. Thus, boot operations do not need to wait for ordinary data-plane communication paths to be configured, initialized, trained, or otherwise made available. The Boot Channel may be used early in boot to transfer boot images or boot information, write boot-control information, read boot-status information, communicate readiness indications, perform boot handshakes, and coordinate transitions between boot stages.

In some embodiments, the Boot Channel remains available after the data-plane channel is enabled. Accordingly, the Boot Channel may continue to support boot management, status reporting, recovery, security, or other control functions even after the SiP has brought up ordinary operational communication paths. In some embodiments, boot-channel communications may later be remapped or supplemented using an enabled data-plane interface, while preserving the ability to use the Boot Channel as an early and reliable communication path.

The combination of distributed hierarchical boot, multi-stage chiplet/SIP boot, and an always-available Boot Channel enables a chiplet-based system-in-package to begin coordinated boot operations before ordinary data-plane traffic is available, to delegate boot responsibility across intermediate chiplets, and to propagate boot status and security information through the boot hierarchy toward a boot-primary chiplet.

In specific embodiments of the invention, a system-in-package is provided. The system-in-package comprises: a first chiplet; a second chiplet; a data-plane channel between the first chiplet and the second chiplet, the data-plane channel configured to carry data-plane traffic between the first chiplet and the second chiplet when the data-plane channel is enabled; and a boot-channel connection between the first chiplet and the second chiplet, the boot-channel connection being distinct from the data-plane channel. The boot-channel connection is configured to, upon supply of power and clock to the first chiplet and the second chiplet, support communication of boot transactions from the first chiplet to the second chiplet before the data-plane channel is enabled to carry the data-plane traffic.

In specific embodiments of the invention, a network of chiplets is provided. The network of chiplets comprises a boot-primary chiplet and a first boot-secondary chiplet. The boot-primary chiplet is configured to initiate a chiplet boot stage of the first boot-secondary chiplet. The network also comprises a second boot-secondary chiplet downstream of the first boot-secondary chiplet in a boot topology of the network of chiplets, a first boot-channel connection between the boot-primary chiplet and the first boot-secondary chiplet, and a second boot-channel connection between the first boot-secondary chiplet and the second boot-secondary chiplet. The first boot-secondary chiplet comprises boot controller circuitry configured to: perform the chiplet boot stage for the first boot-secondary chiplet; communicate first boot information with the boot-primary chiplet over the first boot-channel connection; initiate a chiplet boot stage of the second boot-secondary chiplet over the second boot-channel connection; and transfer, after initiating the chiplet boot stage of the second boot-secondary chiplet, second boot information to the second boot-secondary chiplet over the second boot-channel connection.

In specific embodiments of the invention, a chiplet configured for use as an intermediate boot node in a hierarchical boot topology of a system-in-package is provided. The chiplet comprises: local boot circuitry configured to perform a chiplet boot stage of the chiplet; an upstream boot-channel interface configured to communicate with an upstream self-boot chiplet; a downstream boot-channel interface configured to communicate with a downstream chiplet; and boot controller circuitry coupled to the local boot circuitry, the upstream boot-channel interface, and the downstream boot-channel interface. The boot controller circuitry is configured to: during a first portion of a boot process, operate the chiplet as a boot-secondary chiplet with respect to the upstream self-boot chiplet; perform the chiplet boot stage of the chiplet using the local boot circuitry; after the chiplet boot stage of the chiplet, operate the chiplet as an upstream self-boot chiplet with respect to the downstream chiplet; initiate, through the downstream boot-channel interface, a chiplet boot stage of the downstream chiplet; transfer, through the downstream boot-channel interface, boot information to the downstream chiplet; receive, through the downstream boot-channel interface, boot status information from the downstream chiplet; and forward, through the upstream boot-channel interface, the boot status information toward a boot-primary chiplet.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a layered model of a chiplet architecture in accordance with specific embodiments of the inventions disclosed herein.

FIG. 2 illustrates an example of a chiplet network with a base chiplet in accordance with specific embodiments of the inventions disclosed herein.

FIG. 3 illustrates an example SiP configured to perform flat boot operations using a boot-primary chiplet and multiple boot-secondary chiplets in accordance with specific embodiments of the inventions disclosed herein.

FIG. 4 illustrates an example of a SiP configured to perform hierarchical boot operations in accordance with specific embodiments of the inventions disclosed herein.

FIG. 5 illustrates an example of a boot flow of a SiP where a non-self-boot chiplet mandates secure boot in accordance with specific embodiments of the inventions disclosed herein.

FIG. 6 illustrates an example of a boot flow for a self-boot chiplet and a non-self-boot chiplet where the secondary chiplet does not need a secure boot in accordance with specific embodiments of the inventions disclosed herein.

FIG. 7 illustrates an example of a network of chiplets with an intermediate boot node in a hierarchical boot topology of a SiP in accordance with specific embodiments of the inventions disclosed herein.

FIG. 8 illustrates example boot registers that may be implemented by a boot-secondary chiplet in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for hierarchical multi-stage boots in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

The present disclosure describes a hierarchical multi-stage boot architecture for a system-in-package (SiP) including multiple chiplets. In some embodiments, boot is distributed across a boot topology rather than centralized in a single chiplet that directly boots every other chiplet. A boot-primary chiplet may initiate boot of one or more boot-secondary chiplets, and a boot-secondary chiplet that has completed its own local boot may act as an upstream self-boot chiplet for one or more downstream chiplets. Boot may proceed through multiple stages, including a chiplet boot stage for local chiplet initialization and a later system-in-package boot stage for package-level configuration, inter-chiplet coordination, data-plane enablement, and further software loading.

The disclosed architecture also provides a Boot Channel that is available at the beginning of boot, such as upon supply of power and clock, and that supports boot transactions before a data-plane channel is enabled for ordinary operational traffic. The Boot Channel may be used for reset control, boot-code transfer, boot-control transactions, boot-status reporting, readiness signaling, authentication-related transactions, and coordination between boot stages. These techniques may improve scalability and flexibility of chiplet-based systems by allowing intermediate chiplets to bring up downstream chiplets, reducing reliance on a single centralized boot controller, enabling early boot communication before normal data paths are available, supporting chiplet-designer and SiP-integrator ownership boundaries, and allowing boot status and security information to be propagated through the boot hierarchy.

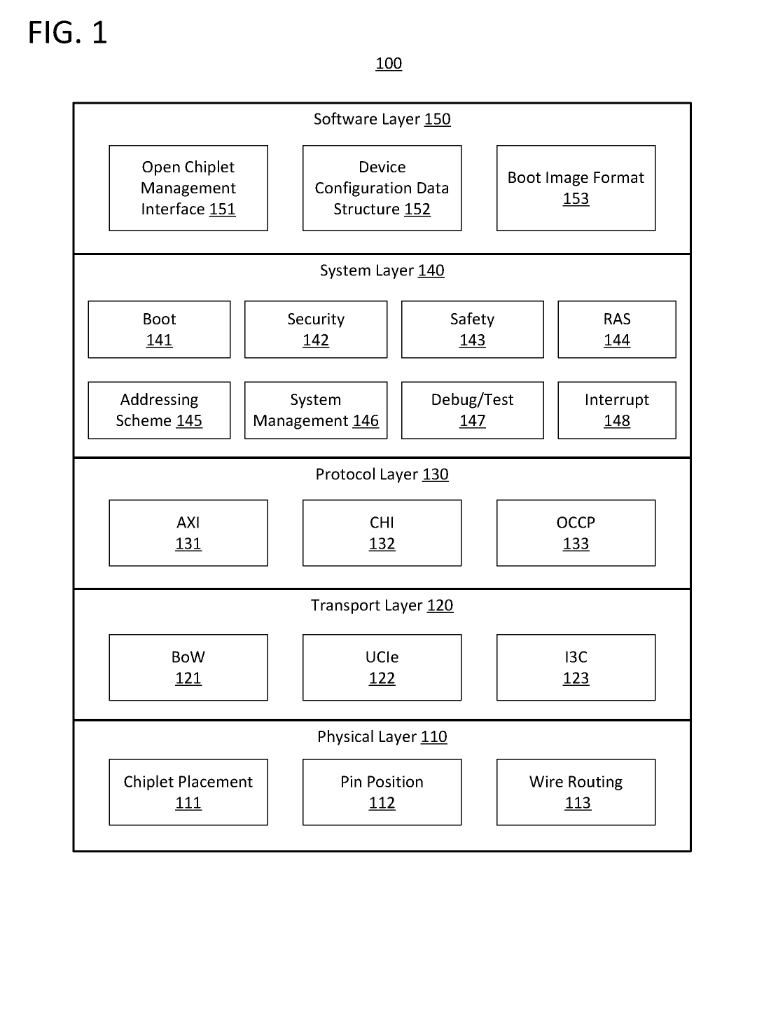

FIG. 1 illustrates layered model 100 of a chiplet architecture in accordance with specific embodiments of the inventions disclosed herein. In the illustrated embodiment, the architecture is organized into physical layer 110, transport layer 120, protocol layer 130, system layer 140, and software layer 150. Booting a chiplet-based SiP may involve coordination across multiple layers of the architecture.

Physical layer 110 may define physical integration aspects of the chiplet system, such as chiplet placement 111, pin position 112, and wire routing 113. Physical layer 110 may represent package-level and physical-implementation considerations used to physically realize communication among chiplets. These resources may be used to physically realize one or more boot communication paths and one or more data-plane communication paths between chiplets.

Transport layer 120 may provide mechanisms for transferring data between chiplets. In the illustrated example, transport layer 120 includes Bunch of Wires (BoW) 121, Universal Chip Interconnect Express (UCIe) 122, and Improved Inter-Integrated Circuit (I3C) 123. These transport mechanisms are shown as examples of lower-layer communication technologies by which information may be conveyed among chiplets, other mechanisms may be used.

Protocol layer 130 may define mechanisms for interpreting data, packets, messages, transactions, or other communication units and for mapping such communications to local fabrics, higher-level system functions, or buses. In the illustrated example, protocol layer 130 includes AXI 131, CHI 132, and Open Chiplet Configuration Protocol (OCCP) 133. OCCP may be a boot and system management protocol. These protocol examples are illustrative, and other protocol arrangements may be used in other embodiments. In the context of boot, transport layer 120 and protocol layer 130 may support early boot transactions used before one or more data-plane channels are enabled, as well as later communications after the system-in-package has been brought into an operational state.

System layer 140 may define system-level functionality distributed across multiple chiplets. In the illustrated example, system layer 140 includes Boot 141; Security 142; Safety 143; Reliability, Availability, Serviceability (RAS) 144; Addressing Scheme 145; System Management 146; Debug/Test 147; and Interrupt 148. These system-layer functions represent architectural functions that enable chiplets to operate together as a coordinated and coherent system. Boot 141 may define architectural boot behavior for the chiplet system, including boot roles, boot topology, boot-stage sequencing, boot synchronization, boot-image transfer, and boot-status reporting.

Software layer 150 may define software-visible interfaces and data structures used to configure, manage, and support operation of the chiplet system. Software layer 150 may define standard device configuration data structures and software interfaces. In the illustrated example, software layer 150 includes Open Chiplet Management Interface 151, Device Configuration Data Structure 152, and Boot Image Format 153. For example, software layer 150 may include configuration data used to identify chiplets, boot roles, boot dependencies, boot-stage information, or package-level configuration information.

In some embodiments of the present disclosure, Boot 141 defines a boot architecture in which a Boot Channel is available at the beginning of boot. The Boot Channel may be distinct from a data-plane channel that carries ordinary operational traffic after the system-in-package has been initialized. Each chiplet may have at least one Boot Channel. The Boot Channel may be immediately ready for use when power and clock are supplied with no configurations required.

The Boot Channel may be used to perform early boot operations such as releasing a chiplet from reset, transferring boot information, writing boot-control information, reading boot-status information, communicating boot readiness, authenticating boot information, and coordinating transitions between boot stages. Because the Boot Channel is available before the data plane is enabled, chiplets may begin coordinated boot operations without waiting for ordinary operational communication paths to be initialized.

Boot 141 may also define a multi-stage boot process. In a chiplet boot stage, a chiplet may perform local initialization, such as local reset, clock, power, security, configuration, and firmware operations. In a later system-in-package boot stage, package-level configuration may be performed across multiple chiplets, and one or more data-plane channels may be enabled for normal operational traffic. This staged boot structure allows chiplet-local initialization to be separated from package-level integration and bring-up.

Boot 141 may further define a hierarchical boot topology in which boot responsibility is distributed across chiplets rather than centralized in a single chiplet that directly boots every other chiplet. For example, a boot-primary chiplet may initiate boot of a boot-secondary chiplet, and the boot-secondary chiplet, after completing its own chiplet boot stage, may operate as an upstream self-boot chiplet for a downstream chiplet. Boot status from the downstream chiplet may be reported through the intermediate chiplet toward the boot-primary chiplet.

The layered arrangement shown in FIG. 1 is illustrative and non-limiting. In various embodiments, one or more layers may be combined, subdivided, omitted, supplemented, or otherwise implemented differently. The boot architecture described herein may be implemented using different physical, transport, protocol, system, and software arrangements, provided that the system supports the described boot behavior, for example early Boot Channel availability, multi-stage boot, hierarchical distribution of boot responsibilities across chiplets, or a combination thereof.

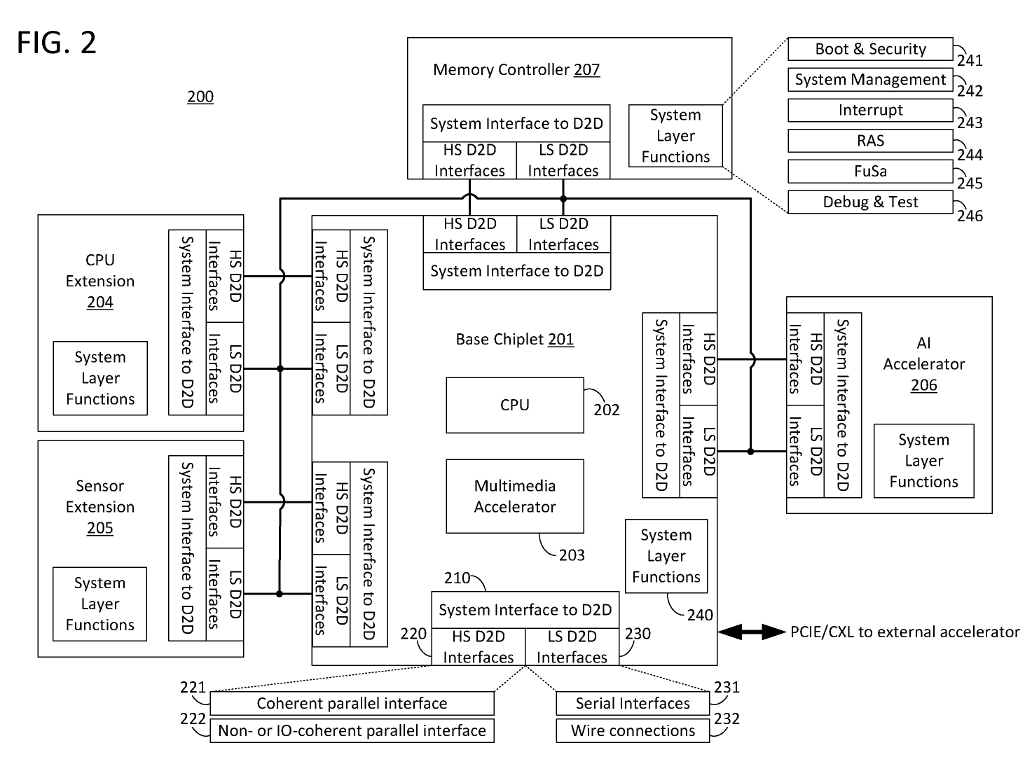

FIG. 2 illustrates an example of chiplet network 200 with base chiplet 201 in accordance with specific embodiments of the inventions disclosed herein. The arrangement of chiplets shown in FIG. 2 is illustrative of an extended chiplet integration in which a base chiplet is coupled to one or more extension chiplets that provide additional compute, memory, sensing, or acceleration functionality. In the illustrated embodiment, chiplet network 200 includes base chiplet 201 having CPU 202 and multimedia accelerator 203. Base chiplet 201 is coupled to additional chiplets, such as CPU extension 204, sensor extension 205, AI accelerator 206, and memory controller 207. In the illustrated example, base chiplet 201 is also shown as being connectable to an external accelerator through a PCIe/CXL connection. Chiplet network 200 may implement a boot architecture in which boot operations are not limited to a single centralized boot controller, but instead may be distributed across multiple chiplets in a boot hierarchy.

One or more chiplets may include a System Interface to die-to-die (D2D) 210 and corresponding high-speed (HS) D2D Interfaces 220 and low-speed (LS) D2D Interfaces 230. In the illustrated example, the System Interface to D2D 210 may serve as an interface between local functional circuitry of a chiplet and die-to-die communication resources used to communicate with other chiplets. The HS D2D Interfaces 220 may correspond to higher-bandwidth chiplet-to-chiplet communication resources, while the LS D2D Interfaces 230 may correspond to lower-bandwidth, control-oriented, or out-of-band communication resources. By way of example, the HS D2D Interfaces 220 may be associated with a coherent parallel interface 221 or a non-coherent or IO-coherent parallel interface 222, while the LS D2D Interfaces 230 may be associated with serial interfaces 231 or wire connections 232. The HS D2D Interfaces 220 may be used to implement one or more data-plane channels that carry ordinary operational traffic after the corresponding data-plane channels are enabled. The LS D2D Interfaces 230, or other out-of-band communication resources, may be used to implement one or more boot-channel connections that support boot transactions before such data-plane channels are enabled. The illustrated interface types are examples, and the boot techniques described herein may use a variety of die-to-die implementations.

In specific embodiments, System Interface to D2D 210 may include or cooperate with a protocol bridge and attribute extension. The protocol bridge and attribute extension may support functions such as address translation and remap, secure communication, functional safety (FuSa) communication, and RAS communication.

In some embodiments, System Interface to D2D 210 may also support boot-related routing or mapping of transactions between local boot circuitry, a Boot Channel, and one or more data-plane channels. For example, boot transactions may be carried over a boot-channel connection during early boot and, after a data-plane channel is enabled, selected boot-related traffic may be remapped, supplemented, or otherwise supported using the enabled data-plane channel. System Interface to D2D 210 can provide adaptation between local chiplet functions and one or more selected die-to-die communication mechanisms, while also carrying channel-related attributes or domain-specific information used for inter-chiplet communication.

In the illustrated embodiment, one or more chiplets further include system layer functions 240. Example system layer functions may include Boot and Security 241, System Management 242, Interrupt 243, RAS 244, FuSa 245, and Debug and Test 246. The system-level functionality of a chiplet may be architecturally distinct from the lower-layer communication resources used to carry inter-chiplet traffic. Boot and Security 241 may include circuitry, firmware, registers, policies, or data structures used to perform local chiplet boot, coordinate boot of downstream chiplets, authenticate boot information, report boot status, or participate in package-level boot of the system-in-package.

Boot and Security 241 may define a Boot Channel as a system-level boot communication path between chiplets. The Boot Channel may be distinct from a data-plane channel and may be configured to support boot transactions when power and clock are supplied to communicating chiplets, including before the data-plane channel is enabled to carry data-plane traffic. Boot transactions may include, for example, boot-control transactions, boot-status transactions, boot-image transfers, boot-loader address or size transfers, reset or readiness handshakes, or security-related boot transactions.

The Boot Channel may be used during early boot to coordinate a boot flow of one or more chiplets. In some embodiments, a first chiplet uses a boot-channel connection to initiate a chiplet boot stage of a second chiplet, transfer boot information to the second chiplet, read boot-status information from the second chiplet, and determine whether the second chiplet is ready to proceed to a later boot stage. The boot-channel connection may remain available after a data-plane channel is enabled, so that boot management, status reporting, recovery, or security-related communication may continue independently of the data-plane channel.

In some embodiments of the present disclosure, one or more of the functions shown in FIG. 2 may be implemented as respective architectural channels at a system layer. For example, a Boot Channel may be defined as a system-layer communication construct that is maintained independently of any one particular bus protocol, transport mechanism, or physical interface. The System Interface to D2D of a chiplet may then map traffic of a selected architectural channel to an available and compatible lower-layer implementation, such as an HS D2D interface or an LS D2D interface, depending on operating state, interface availability, or compatibility between communicating chiplets. In this manner, the identity of the architectural channel may be preserved while the physical realization used to carry that channel changes.

Although FIG. 2 illustrates an extended integration using a base chiplet 201, the disclosed subject matter is not limited to that organization. In other embodiments, a chiplet network may use a centralized chiplet or hub chiplet that primarily provides interconnection among chiplets, rather than serving as a base chiplet to which extension chiplets are attached. In still other embodiments, a chiplet network may use a distributed topology without a hub, in which chiplets communicate through peer-to-peer or otherwise distributed interconnections and each participating chiplet includes corresponding system-interface-to-D2D functionality and system-layer functions. Thus, the particular physical organization of chiplets may vary while still using system-layer architectural channels and lower-layer channel mappings.

Accordingly, FIG. 2 should be understood as one non-limiting example of a chiplet network in which chiplet functions are partitioned across multiple chiplets, system-layer functions are maintained separately from lower-layer D2D communication resources, and architectural channels may be mapped onto different physical communication resources within the chiplet network. The number, type, and placement of chiplets, as well as the particular organization of the System Interface to D2D, HS D2D Interfaces, LS D2D Interfaces, protocol bridges, and system layer functions, may vary in different embodiments.

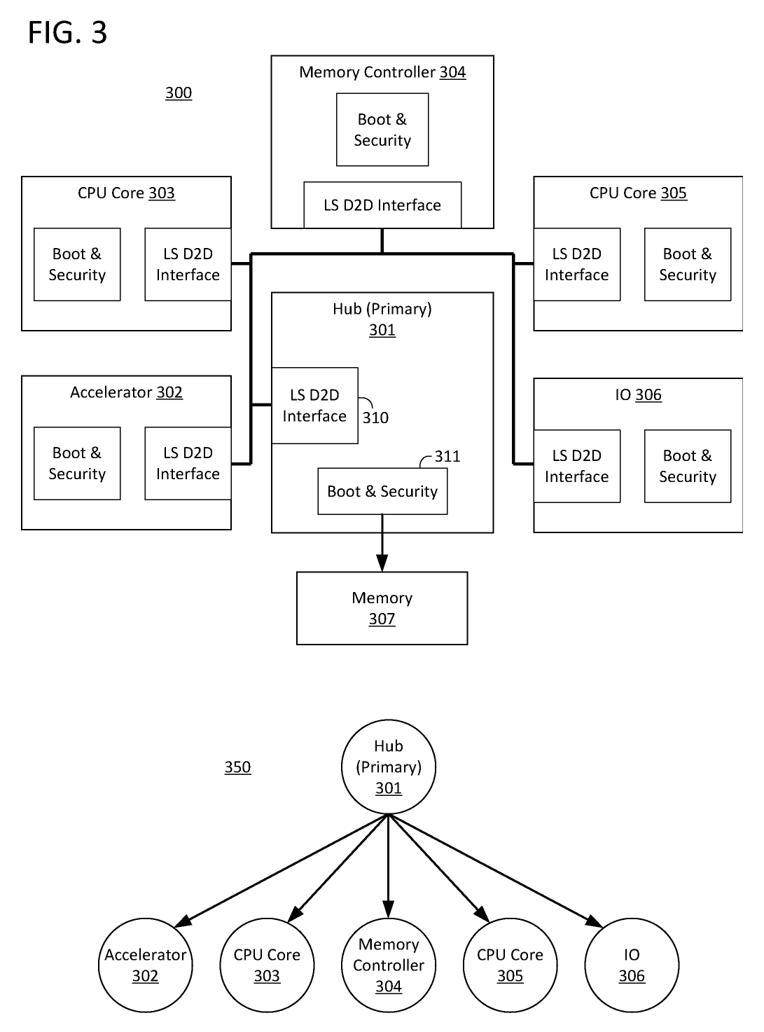

FIG. 3 illustrates an example of a hierarchical chiplet system architecture 300. In hierarchical system architectures, where chiplets can assume different roles, some chiplets may act as primaries while other chiplets may act as secondaries. A primary chiplet serves as the main control element for a specific functional domain. For each functional domain, there may be a single primary chiplet in a package, while other chiplets operate as secondaries. Different functional domains may have different requirements for the primary chiplet. For example, a boot primary chiplet may have the requirement of booting first, having access to necessary peripheral interfaces, and booting up the rest of the SiP. As another example, the system management primary chiplet may oversee the system management tasks for the whole SiP and may interface to the system software. In specific embodiments, a single chiplet may serve as the primary chiplet across all function domains. In specific embodiments, a SiP integrator may choose to designate different chiplets as the primary for distinct function domains, for example, assigning separate primary chiplets for Security/Boot/Debug/DFT (Design for Test) and for System Management/System Time Management/RAS/FuSa. A chiplet intended to serve as the central controller of the SiP may be designed to support the primary functions of all relevant domains. Chiplets may be designed with secondary capabilities and interfaces to support multi-instantiation and to provide the SiP integrator with the flexibility to designate the appropriate primary for each function domain.

FIG. 3 further illustrates a directed acyclic graph topology 350 corresponding to the system of FIG. 3, in which hub chiplet 301 serves as the root node and accelerator chiplet 302, CPU core chiplet 303, memory controller chiplet 304, CPU core chiplet 305, and I/O chiplet 306 serve as leaf nodes. In specific embodiments, chiplets in a package and their connections may form a Directed Acyclic Graph. Each node in the graph may correspond to a chiplet. The edges may indicate physical connections between chiplets. The direction of the edges may not define uni- or bi-directional traffic; instead, the direction may specify the management hierarchy. Following the direction of a directed edge, the graph moves from an upstream chiplet to a downstream chiplet. The upstream chiplet may be at the same or higher management level than the downstream. The topology may include roots, leafs, and non-leafs organized upstream and downstream relative to each other. Chiplets that are upstream of a given chiplet may be chiplets that have a directed path to that chiplet. Chiplets that are downstream of a given chiplet may be chiplets that can be reached from that chiplet via a directed path. The topology root of a directed acyclic graph may also be the primary chiplet in a function domain. A leaf may be an end chiplet with no downstream chiplet. A non-leaf may be an intermediate chiplet with at least one upstream chiplet and one downstream chiplet. The topology view may be domain specific. The primary chiplet of a functional domain may sit at the root of that functional domain’s topology view. Information about the chiplet topology configuration may be provided to software through a data structure. The SiP integrator may provide the data structure. In specific embodiments, topology may be fixed after packaging such that no discovery is required during boot time or run time.

FIG. 3 illustrates an example SiP 300 configured to perform boot operations using a boot-primary chiplet and multiple boot-secondary chiplets in accordance with specific embodiments of the inventions disclosed herein. In the illustrated embodiment, SiP 300 includes hub chiplet 301, accelerator chiplet 302, CPU core chiplet 303, memory controller chiplet 304, CPU core chiplet 305, I/O chiplet 306, and memory 307. Hub chiplet 301 is illustrated as a primary chiplet for the boot domain. Accelerator chiplet 302, CPU core chiplet 303, memory controller chiplet 304, CPU core chiplet 305, and I/O chiplet 306 are illustrated as boot-secondary chiplets with respect to hub chiplet 301.

Hub chiplet 301 may be a boot primary chiplet. The boot primary chiplet may be a self-boot chiplet that boots first in the SiP. A self-boot chiplet may be self-sufficient in loading its configuration and software. It may have the capability and the system setup to boot by itself. A self-boot chiplet may also help load configuration and software to other non-self-boot chiplets. A SiP may have one chiplet that is designated as the boot primary chiplet and may have Boot Channels for inter-chiplet communications. In specific embodiments, the SiP may have chiplets that are configured as boot secondary chiplets.

In specific embodiments, hub chiplet 301 may be the only self-boot chiplet in a SiP. In such case, hub chiplet 301 may be responsible for the boot up of all the Boot Secondary chiplets. The centralized hub chiplet may boot up first, with a non-volatile memory 307 attached via an implementation-defined interface. Acting as the Boot Primary chiplet, this Hub chiplet may be responsible for configuring and loading software or data to all Boot Secondary chiplets. During the early stages of the boot process, communication between the primary and secondary chiplets may occur over the Boot Channel running on the low-speed D2D connection.

Each chiplet in SiP 300 may include one or more low-speed die-to-die interfaces 310 and boot and security circuitry 311. Low-speed die-to-die interfaces 310 may be used to implement boot-channel connections between hub chiplet 301 and the respective boot-secondary chiplets. Boot and security circuitry 311 may include circuitry, firmware, registers, local boot resources, security resources, or other logic used to perform boot operations, security operations, boot-status reporting, authentication of boot information, or coordination of boot stages.

In the illustrated embodiment, hub chiplet 301 is coupled to accelerator chiplet 302, CPU core chiplet 303, memory controller chiplet 304, CPU core chiplet 305, and I/O chiplet 306 through boot-channel connections implemented using low-speed die-to-die interfaces 310. The boot-channel connections may be distinct from one or more data-plane channels used to carry ordinary operational traffic after SiP 300 has been initialized. In some embodiments, the boot-channel connections are configured to support boot transactions upon supply of power and clock to communicating chiplets, before the corresponding data-plane channels are enabled.

Memory 307 may store boot information used during boot of SiP 300. For example, memory 307 may store one or more boot images, boot loaders, system-in-package-stage boot code, chiplet configuration data, package configuration data, boot topology information, security information, or other information used by hub chiplet 301 to coordinate boot of the system-in-package. In some embodiments, hub chiplet 301 may retrieve boot information from memory 307 and may transfer boot information to one or more boot-secondary chiplets over corresponding boot-channel connections.

Hub chiplet 301 may boot first and may use its boot and security circuitry 311 to perform a chiplet boot stage for hub chiplet 301. After hub chiplet 301 has completed sufficient local boot operations, hub chiplet 301 may coordinate boots of the boot-secondary chiplets. For example, hub chiplet 301 may use boot-channel connections to release a boot-secondary chiplet from reset, transfer boot information, write boot-control information, read boot-status information, determine readiness of the boot-secondary chiplet, or otherwise synchronize boot of the boot-secondary chiplet.

A boot-secondary chiplet, such as accelerator chiplet 302, CPU core chiplet 303, memory controller chiplet 304, CPU core chiplet 305, or I/O chiplet 306, may use its respective boot and security circuitry 311 to perform a chiplet boot stage. During the chiplet boot stage, the boot-secondary chiplet may perform local configuration of circuitry of the chiplet, load or verify chiplet-stage boot code, initialize local resources, prepare local security state, or generate boot-status information. Hub chiplet 301 may communicate with the boot-secondary chiplet over the boot-channel connection before a data-plane channel associated with that boot-secondary chiplet is enabled to carry data-plane traffic.

After one or more chiplets complete their respective chiplet boot stages, SiP 300 may proceed to a SiP boot stage. During the SiP boot stage, hub chiplet 301, alone or in cooperation with one or more boot-secondary chiplets, may perform package-level configuration, coordinate multiple chiplets, configure system-level resources, enable one or more data-plane channels, or load later-stage software. Chiplet-local boot operations may be performed before package-level boot operations.

The boot-channel connections shown in FIG. 3 may also be used for boot-status reporting. For example, each boot-secondary chiplet may provide boot-status information to hub chiplet 301 over a corresponding boot-channel connection. Boot-status information may indicate, for example, whether the boot-secondary chiplet is ready to accept boot information, whether a boot-image transfer has completed, whether local chiplet-stage boot has completed, whether the chiplet is ready for a later system-in-package boot stage, whether a security verification has passed or failed, or whether the chiplet has encountered a boot error.

Boot topology 350 of hierarchy diagram of SiP 300 shows hub chiplet 301 as the root of the boot topology and the boot-primary chiplet. Accelerator chiplet 302, CPU core chiplet 303, memory controller chiplet 304, CPU core chiplet 305, and I/O chiplet 306 are downstream boot-secondary chiplets. The arrows in boot topology 350 indicate boot-domain relationships from the upstream boot-primary chiplet to downstream boot-secondary chiplets. The arrows may not indicate that communication is limited to one direction; rather, they may identify the boot-management hierarchy used for boot initiation, boot synchronization, and boot-status reporting. Boot topology 350 is an example of a flat boot topology in which hub chiplet 301 directly coordinates boot of each illustrated boot-secondary chiplet.

Although FIG. 3 illustrates low-speed die-to-die interfaces 310 as resources used to implement boot-channel connections, other physical, transport, or protocol mechanisms may be used. Likewise, the number and type of chiplets shown in FIG. 3 are examples. Other embodiments may include additional or fewer chiplets, different types of chiplets, different package topologies, different boot-primary chiplets, different memory arrangements, or different implementations of boot and security circuitry while still using the boot-channel and staged boot techniques described herein.

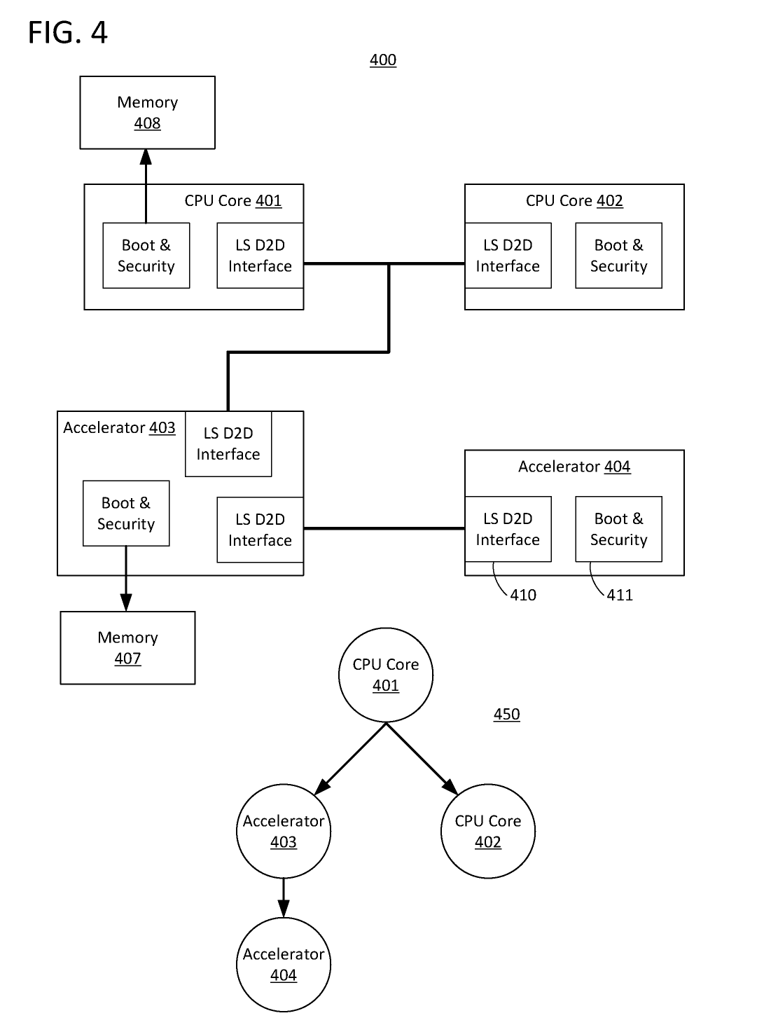

FIG. 4 illustrates an example SiP 400 configured to perform hierarchical boot operations in accordance with specific embodiments of the inventions disclosed herein. In SiP 400, boot responsibility is distributed across multiple chiplets instead of being centralized in a single chiplet that directly boots every other chiplet in the SiP. In the illustrated embodiment, SiP 400 includes CPU core chiplet 401, CPU core chiplet 402, accelerator chiplet 403, accelerator chiplet 404, memory 407, and memory 408. Each chiplet may include one or more low-speed die-to-die interfaces 410 and boot and security circuitry 411. Low-speed die-to-die interfaces 410 may be used to implement boot-channel connections among chiplets. Boot and security circuitry 411 may include circuitry, firmware, registers, security resources, authentication logic, boot-control logic, local boot resources, or other resources used to perform chiplet boot, SiP boot, boot-image handling, boot-status reporting, or secure boot operations.

CPU core chiplet 401 is illustrated as a boot-primary chiplet for the boot topology of SiP 400. CPU core chiplet 401 may boot first and may initiate boot operations for one or more downstream chiplets. In the illustrated embodiment, CPU core chiplet 401 is upstream of CPU core chiplet 402 and accelerator chiplet 403 in the boot topology. CPU core chiplet 401 may use one or more boot-channel connections implemented through low-speed die-to-die interfaces 410 to communicate boot transactions with CPU core chiplet 402 and accelerator chiplet 403.

A boot primary chiplet can be a self-boot chiplet. A Boot Secondary chiplet may be a self-boot chiplet and may be responsible for the boot up of one or more other Boot Secondary chiplets. This may result in a multi-layer hierarchical boot structure within the SiP. In the example of FIG. 4, Accelerator chiplet 403 may function as both a Boot Secondary chiplet and a self-boot chiplet. It may be responsible for booting up Accelerator chiplet 404. A connection between the Boot Primary CPU core chiplet 401 and the self-boot Accelerator chiplet 403 may still be required for boot synchronization and boot status report.

Accelerator chiplet 403 is illustrated as an intermediate boot node. During an earlier portion of a boot process, accelerator chiplet 403 operates as a boot-secondary chiplet with respect to CPU core chiplet 401. For example, accelerator chiplet 403 may receive boot-control commands from CPU core chiplet 401 over a boot-channel connection, while loading its boot image and configuration from its own local memory. Accelerator chiplet 403 may then perform a chiplet boot stage using its boot and security circuitry 411. A self-boot chiplet may use a Boot Channel to communicate with other chiplets. Each boot secondary chiplet may connect directly to one and only one upstream self-boot chiplet.

After accelerator chiplet 403 completes sufficient local boot operations, accelerator chiplet 403 may operate as an upstream self-boot chiplet with respect to accelerator chiplet 404. In this role, accelerator chiplet 403 may initiate a chiplet boot stage of accelerator chiplet 404 over a boot-channel connection between accelerator chiplet 403 and accelerator chiplet 404. Accelerator chiplet 403 may also transfer boot information to accelerator chiplet 404, write boot-control information to accelerator chiplet 404, read boot-status information from accelerator chiplet 404, authenticate boot information for accelerator chiplet 404, or receive readiness indications from accelerator chiplet 404.

Thus, accelerator chiplet 403 may have different relative boot roles during the boot process. Accelerator chiplet 403 may be a boot-secondary chiplet relative to upstream CPU core chiplet 401 and, after completing its own chiplet boot stage, may act as an upstream self-boot chiplet relative to downstream accelerator chiplet 404. Accelerator chiplet 403 need not become the boot-primary chiplet for the entire SiP 400. Rather, accelerator chiplet 403 acts as an upstream boot agent for a downstream portion of the boot topology.

CPU core chiplet 402 may be another boot-secondary chiplet downstream of CPU core chiplet 401. CPU core chiplet 401 may directly initiate or coordinate a chiplet boot stage of CPU core chiplet 402 over a corresponding boot-channel connection. CPU core chiplet 402 may use its boot and security circuitry 411 to perform local chiplet boot operations and to report boot status to CPU core chiplet 401.

The boot-channel connections implemented through low-speed die-to-die interfaces 410 may be distinct from one or more data-plane channels used to carry ordinary operational traffic after system-in-package 400 has been initialized. In some embodiments, the boot-channel connections are configured to support boot transactions upon supply of power and clock to communicating chiplets, including before such data-plane channels are enabled. Boot transactions may include reset release, boot-control commands, boot-image transfer, boot-loader address or size information, boot-status reads, readiness indications, authentication-related transactions, or boot-stage synchronization.

In some embodiments, boot of SiP 400 may proceed in multiple stages. During a chiplet boot stage, a chiplet performs local initialization of circuitry of the chiplet, such as local reset, clock, power, configuration, security, or firmware operations. During a later SiP boot stage, package-level configuration may be performed across multiple chiplets, and one or more data-plane channels may be enabled to carry ordinary data-plane traffic. The boot-channel connections may be used to coordinate transitions between the chiplet boot stage and the system-in-package boot stage.

Memory 408 may be associated with CPU core chiplet 401 and may store boot information used by CPU core chiplet 401 during boot. Memory 407 may be associated with accelerator chiplet 403 and may store boot information used by accelerator chiplet 403, including boot information for accelerator chiplet 403 or accelerator chiplet 404. In various embodiments, memory 407 or memory 408 may store boot images, boot loaders, chiplet-stage boot code, system-in-package-stage boot code, package configuration data, boot topology data, security information, or other information used during boot. In specific embodiments, memory 408 and memory 407 may be non-volatile boot storage. In specific embodiments, memory 408 and memory 407 may be general system memory.

Boot topology 450 of SiP 400 shows CPU core chiplet 401 as the root of the boot topology and the boot-primary chiplet. CPU core chiplet 402 and accelerator chiplet 403 are downstream of CPU core chiplet 401. Accelerator chiplet 404 is downstream of accelerator chiplet 403. The arrows in boot topology 450 identify boot-domain hierarchy and may be used for boot initiation, boot synchronization, boot-information transfer, and boot-status reporting. The arrows need not indicate that communication is limited to a single direction.

Boot-status reporting may follow the hierarchical boot topology. For example, accelerator chiplet 404 may report boot status to accelerator chiplet 403 over a boot-channel connection. Accelerator chiplet 403 may aggregate boot status received from accelerator chiplet 404 with boot status of accelerator chiplet 403 and may forward the aggregated boot status toward CPU core chiplet 401. CPU core chiplet 402 may report boot status directly to CPU core chiplet 401. CPU core chiplet 401 may thereby obtain boot-status information for downstream chiplets without directly controlling every boot-secondary chiplet in the system-in-package.

The hierarchical arrangement shown in FIG. 4 is illustrative. In other embodiments, different chiplets may serve as the boot-primary chiplet or as intermediate boot nodes, additional levels of downstream chiplets may be included, and a given intermediate chiplet may boot one or more downstream chiplets. The boot-channel connections may be implemented using low-speed die-to-die interfaces 410 or other communication resources suitable for early boot transactions. Likewise, memories 407 and 408 may be implemented using different memory technologies or may be replaced or supplemented by other sources of boot information.

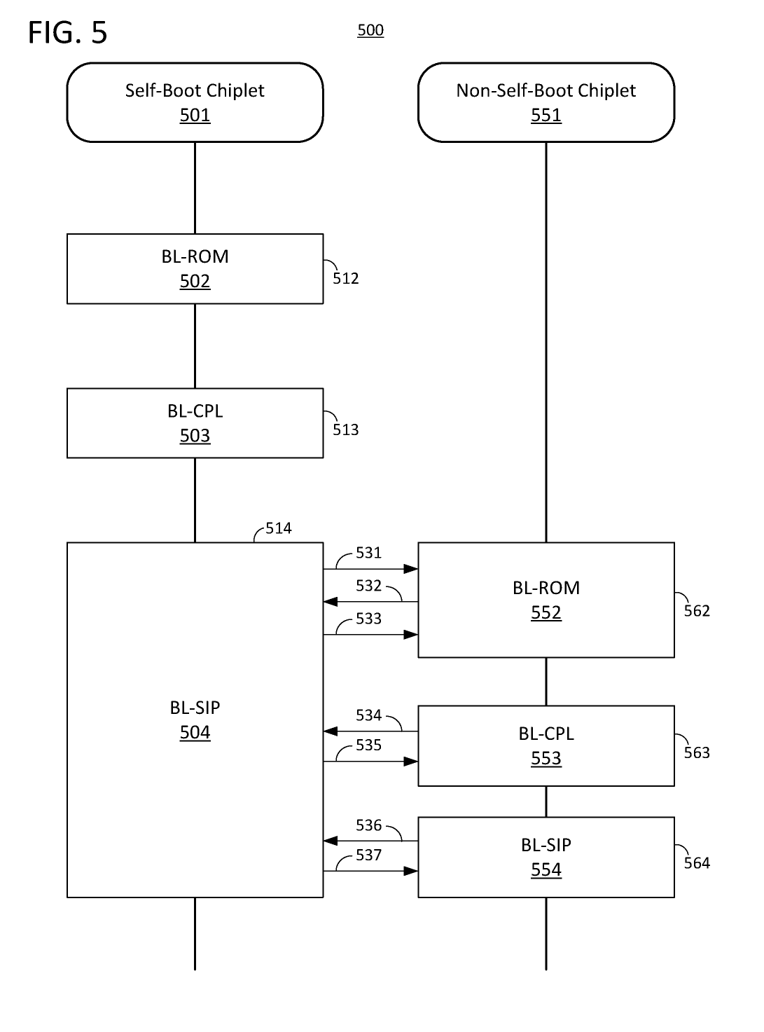

FIG. 5 illustrates an example of boot flow 500 of a SiP where a non-self-boot chiplet mandates secure boot in accordance with specific embodiments of the inventions disclosed herein. Chiplets may be configured to execute initial boot code stored in boot ROM, to load or verify chiplet-stage boot code, and to execute SiP-stage boot code. The partitioning of the boot stages may consider the ownership difference between chiplet and SiP. For example, a chiplet designer may control or authenticate chiplet-local boot code, while a system-in-package integrator may control or authenticate boot code used to configure the integrated package.

For self-boot chiplet 501, boot flow 500 includes boot loader ROM (BL-ROM) stage 502 executing BL-ROM code 512, boot loader chiplet (BL-CPL) stage 503 executing BL-CPL code 513, and boot loader SiP (BL-SIP) stage 504 executing BL-SIP code 514. For non-self-boot chiplet 551, boot flow 500 includes BL-ROM stage 552 executing BL-ROM code 562, BL-CPL stage 553 executing BL-CPL code 563, and BL-SIP stage 554 executing BL-SIP code 564. In some embodiments, BL-SIP code 514 for self-boot chiplet 501, BL-CPL code 563 for non-self-boot chiplet 551, and BL-SIP code 564 for non-self-boot chiplet 551 may be bundled together and signed with a private key of the SiP integrator. Within the bundle, BL-CPL code 563 may additionally be signed with a private key of the designer of non-self-boot chiplet 551, thereby allowing chiplet-local code to be authenticated according to chiplet-designer trust policy while package-level code is authenticated according to SiP integrator trust policy.

BL-ROM, BL-CPL, and BL-SIP are conceptual boot-code components or execution stages and do not require separate dedicated physical hardware blocks. In some embodiments, multiple stages may be executed by common boot-control circuitry or by overlapping sets of processors, controllers, sequencers, state machines, secure-boot engines, or other boot resources. BL-ROM code may be stored in ROM, while BL-CPL code and BL-SIP code may be stored in non-volatile memory, loaded into SRAM, transferred over the Boot Channel, verified, and then executed by a processor, controller, state machine, or other boot-control circuitry.

Generally, a Chiplet Boot Stage may finish the chiplet's local configurations and firmware loading to make it ready for further SiP bring up in the SiP Boot Stage. The chiplet boot stage may include, but is not limited to, enabling chiplet-local power resources, releasing local resets, configuring clocking resources such as phase-locked loops (PLLs), initializing local interconnect or fabric resources, configuring local memory or register resources, and applying subsystem-specific settings. The chiplet boot stage may also enforce chiplet-designer restrictions or policies, including feature enablement, performance limits, debug restrictions, lifecycle state, or other intellectual-property-protection settings. BL-ROM and BL-CPL stages may be associated with this stage. BL-ROM may provide the immutable initial code path, while BL-CPL may provide mutable chiplet-stage code executed after BL-ROM to perform more extensive local configuration. In some embodiments, BL-CPL is optional and may be omitted when the functionality of BL-ROM is sufficient for a particular chiplet.

The SiP boot stage may perform operations that involve the integrated package rather than only a single chiplet. The SiP boot stage may include updating local chiplet configurations based on package-level information, coordinating multiple chiplets, configuring package-level address maps or routing, bringing up inter-chiplet communication paths, enabling data-plane channels, and loading later software stages. The software running during this stage may be referred to as BL-SIP. BL-SIP may be developed, configured, signed, or otherwise controlled by the SiP integrator because it may depend on the final package composition, chiplet topology, memory map, boot topology, security policy, and inter-chiplet communication arrangement selected for the system-in-package.

BL-ROM may refer to initial boot code stored in immutable, read-only, one-time-programmable, mask-programmed, fused, or otherwise trusted storage of a chiplet. BL-ROM may also refer to the storage structure containing such initial boot code or the stage of a boot process executing such initial boot code. BL-ROM may be the first boot code executed, or among the first boot code executed, by boot control circuitry of a chiplet after reset, power-on, or another boot-start event. BL-CPL may refer to chiplet-stage boot code, firmware, a boot image, or an execution stage used to perform local boot operations for an individual chiplet after execution of BL-ROM. BL-CPL may be mutable boot code loaded from non-volatile memory, received over a Boot Channel, loaded into local memory, or otherwise made available to the chiplet. BL-SIP may refer to SiP-stage boot code, firmware, a boot image, or an execution stage used to perform package-level boot operations after one or more chiplet-stage boot operations have been performed. BL-SIP may perform operations that depend on the final system-in-package configuration. BL-CPL may be associated with chiplet-local boot and BL-SIP may be associated with SiP-level boot.

The terms BL-ROM, BL-CPL, and BL-SIP are used to identify boot code components, boot images, or boot execution stages, and do not require separate dedicated physical hardware blocks unless expressly stated. For example, BL-ROM may be stored in a physical ROM or other trusted storage, while BL-CPL and BL-SIP may be stored in non-volatile memory, transferred over a Boot Channel, loaded into SRAM or another local memory, and executed by one or more processors, sequencers, state machines, microcontrollers, secure-boot engines, or other boot control circuitry. Likewise, a reference to a chiplet “including” BL-ROM, BL-CPL, or BL-SIP may mean that the chiplet includes storage containing the corresponding code, is configured to receive the corresponding code, or is configured to execute the corresponding boot stage.

BL-ROM code 512 of self-boot chiplet 501 may execute first when self-boot chiplet 501 begins booting. BL-ROM stage 502 may determine an applicable boot path, such as a secure boot path or an insecure boot path, a primary boot path or a secondary boot path, a self-boot path or a non-self-boot-assist path, and a regular boot path or a recovery boot path. These boot-path decisions may be based on fuses, straps, lifecycle state, reset cause, security policy, package configuration data, or other boot configuration information. BL-ROM stage 502 may then load BL-CPL code 513 from a non-volatile memory or other boot source and verify BL-CPL code 513 using a public key associated with the chiplet designer. Verification may include signature verification, hash checking, version checking, anti-rollback checking, or other integrity and authenticity checks. If verification fails, BL-ROM stage 502 may halt boot, enter a recovery mode, or report a boot failure.

After BL-CPL code 513 has been loaded and verified, BL-CPL code 513 may execute on self-boot chiplet 501 to perform chiplet-local initialization. BL-CPL stage 503 may configure or bring up local functional blocks, local fabrics, local memory controllers, local security resources, or other components of self-boot chiplet 501. BL-CPL stage 503 may also establish a local trusted state for self-boot chiplet 501 before self-boot chiplet 501 participates in booting other chiplets. For example, BL-CPL stage 503 may lock configuration registers, disable unauthorized debug features, configure access-control settings, or apply performance and feature constraints required by the chiplet designer. Once self-boot chiplet 501 has reached a sufficient local boot state, it may be capable of executing BL-SIP code 514 and coordinating boot of non-self-boot chiplet 551.

BL-CPL stage 503 may load and verify one or more boot components for self-boot chiplet 501 and downstream non-self-boot chiplets. These components may include BL-SIP code 514 for self-boot chiplet 501, BL-CPL code 563 for non-self-boot chiplet 551, and BL-SIP code 564 for non-self-boot chiplet 551. In some embodiments, BL-CPL stage 503 may verify an integrator-signed boot bundle using a public key associated with the SiP integrator. The bundle may identify target chiplets, boot-image sizes, boot-loader addresses, version information, security metadata, and policy information. By verifying the bundle before distributing boot information, self-boot chiplet 501 may ensure that only authorized package-level boot information is provided to downstream chiplets over the Boot Channel.

After BL-SIP stage 504 begins execution on self-boot chiplet 501, self-boot chiplet 501 may act as an upstream boot agent for non-self-boot chiplet 551. In that role, self-boot chiplet 501 may use an always-available Boot Channel to communicate boot transactions to non-self-boot chiplet 551 before one or more data-plane channels are enabled for ordinary operational traffic. The Boot Channel may be used for reset control, boot-loader transfer, boot-status reads, readiness notifications, security-related boot transactions, and boot-stage synchronization. The Boot Channel may allow self-boot chiplet 501 to coordinate boot of non-self-boot chiplet 551 even though non-self-boot chiplet 551 may not yet have sufficient local software or enabled data-plane connectivity to participate in normal system communication.

BL-SIP stage 504 may power on non-self-boot chiplet 551 or release non-self-boot chiplet 551 from reset as needed. At step 531, self-boot chiplet 501 may perform a reset release or equivalent boot-start operation for non-self-boot chiplet 551. After reset release, BL-ROM code 562 on non-self-boot chiplet 551 may execute and determine an applicable boot path, such as secure versus insecure, primary versus secondary, self-boot versus non-self-boot, or regular versus recovery. Because non-self-boot chiplet 551 does not independently obtain all mutable boot code needed for later boot stages, BL-ROM stage 552 may configure non-self-boot chiplet 551 to receive BL-CPL code 563 from self-boot chiplet 501. At step 532, non-self-boot chiplet 551 may communicate to self-boot chiplet 501 that it is ready to accept BL-CPL code 563. At step 533, self-boot chiplet 501 may then distribute BL-CPL code 563 to non-self-boot chiplet 551 over the Boot Channel. Self-boot chiplet 501 may communicate that transfer of BL-CPL code 563 is complete. Because non-self-boot chiplet 551 mandates secure boot in this example, BL-ROM stage 552 may verify BL-CPL code 563 using a public key associated with the chiplet designer before allowing BL-CPL code 563 to execute.

The exchange at steps 531, 532, and 533 may be implemented using boot transactions over the Boot Channel. For example, self-boot chiplet 501 may write a boot-control register of non-self-boot chiplet 551 to release reset or authorize receipt of boot code. Non-self-boot chiplet 551 may expose a boot-status register indicating that it is ready to receive BL-CPL code 563. Self-boot chiplet 501 may provide a boot-loader address, boot-loader size, or boot-image payload corresponding to BL-CPL code 563. After the transfer completes, self-boot chiplet 501 may signal completion, and non-self-boot chiplet 551 may update its boot status to indicate whether BL-CPL code 563 was received and verified successfully. These transactions may occur before any ordinary data-plane channel between the chiplets is enabled.

BL-CPL code 563 may then execute on non-self-boot chiplet 551 to perform chiplet-local configuration for non-self-boot chiplet 551. Similar to BL-CPL stage 503, BL-CPL stage 553 may configure local chiplet resources such as local fabric, local memory resources, security state, reset domains, clocks, or subsystem-specific settings. BL-CPL stage 553 may also apply chiplet-designer policies, such as disabling unauthorized features, locking security-sensitive configuration, or enforcing performance or lifecycle constraints. After completing sufficient local initialization, BL-CPL stage 553 may configure non-self-boot chiplet 551 to receive BL-SIP code 564 from self-boot chiplet 501, thereby preparing non-self-boot chiplet 551 to transition from the chiplet boot stage toward the SiP boot stage.

At step 534, non-self-boot chiplet 551 may communicate to self-boot chiplet 501 that it is ready to accept BL-SIP code 564. This readiness indication may be provided through a boot-status register, a boot-ready message, an interrupt-like indication, or another Boot Channel transaction. In response, BL-SIP stage 504 may distribute BL-SIP code 564 to non-self-boot chiplet 551 via the Boot Channel. Because BL-SIP code 564 may include package-level configuration code or policy supplied by the SiP integrator, BL-SIP code 564 may be authenticated using a public key associated with the SiP integrator. This may allow non-self-boot chiplet 551 to distinguish chiplet-designer-authenticated code used for local chiplet bring-up from integrator-authenticated code used for package-level bring-up.

At step 535, self-boot chiplet 501 may transfer BL-SIP code 564 to non-self-boot chiplet 551. Self-boot chiplet 501 may communicate to non-self-boot chiplet 551 that transfer of BL-SIP code 564 is complete. Upon receipt of BL-SIP code 564, BL-CPL stage 553 may verify BL-SIP code 564 using the SiP integrator’s public key before allowing BL-SIP code 564 to execute. If verification succeeds, BL-SIP code 564 may begin performing SiP-stage operations for non-self-boot chiplet 551. If verification fails, non-self-boot chiplet 551 may prevent execution of BL-SIP code 564 and may report a verification failure to self-boot chiplet 501 over the Boot Channel. Self-boot chiplet 501 may then halt downstream boot, enter a recovery procedure, request a replacement image, or report the failure toward a boot-primary chiplet or management controller.

BL-SIP stage 554 may configure non-self-boot chiplet 551 for participation in package-level operation. For example, BL-SIP stage 554 may configure address mapping, routing, security domains, interface state, local resources needed for inter-chiplet communication, or readiness for data-plane enablement. In embodiments that include a high-speed die-to-die connection, BL-SIP stage 554 may configure non-self-boot chiplet 551 to be ready for die-to-die link initialization or training. At step 536, non-self-boot chiplet 551 may communicate to self-boot chiplet 501 that it is ready for the later package-level bring-up operation, such as D2D training or data-plane enablement. This indication may allow self-boot chiplet 501 to coordinate package-level bring-up across one or more downstream chiplets rather than enabling data-plane communication before the downstream chiplets are prepared.

When the relevant non-self-boot chiplets are ready, BL-SIP stage 504 may configure the SiP so that the chiplets operate together as a coordinated system. These operations may include distributing or configuring base address registers, configuring fabric routing, configuring address remapping, establishing package-level security policy, enabling system-level communication paths, and bringing up data-plane channels. At step 537, self-boot chiplet 501 may initiate the later package-level bring-up operation for non-self-boot chiplet 551, such as D2D training or enabling a data-plane channel. After this point, the local boot process of non-self-boot chiplet 551 may be complete, and the system-in-package may continue booting in a manner analogous to a monolithic system-on-chip, with the chiplets operating as coordinated components of the integrated package.

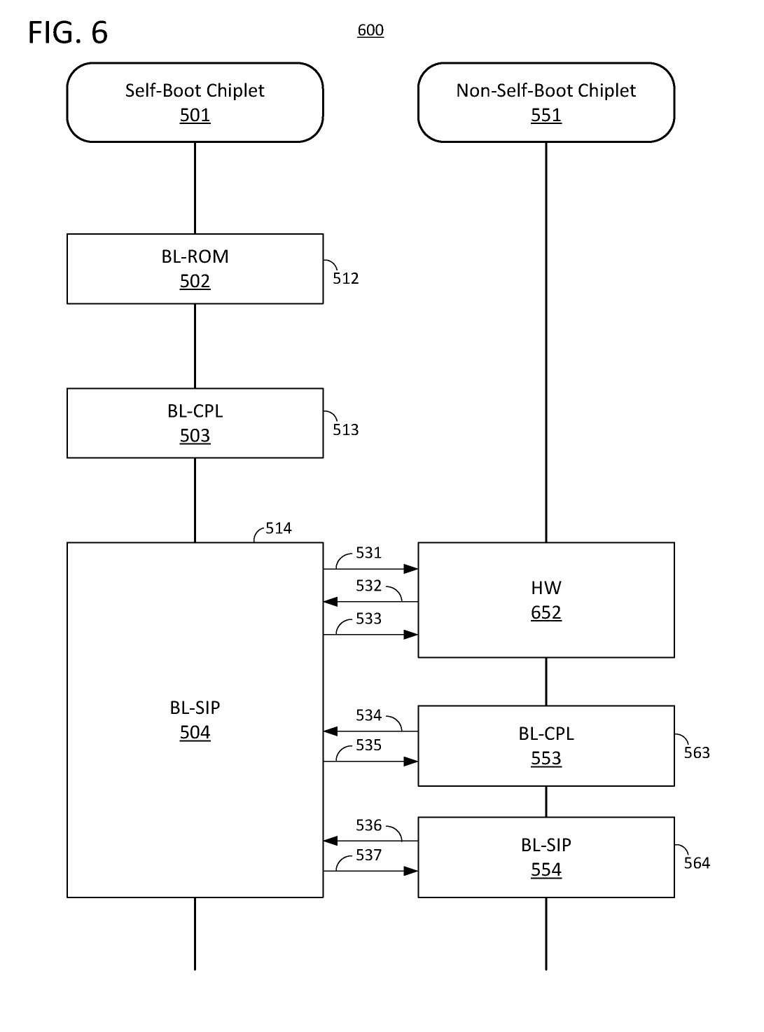

FIG. 6 illustrates another example boot flow 600 for a self-boot chiplet 501 and a non-self-boot chiplet 551 in accordance with specific embodiments of the inventions disclosed herein. Boot flow 600 may be similar to boot flow 500 of FIG. 5, except that non-self-boot chiplet 551 does not mandate local secure boot before executing mutable boot code. Accordingly, instead of executing a BL-ROM stage that verifies BL-CPL code before execution, non-self-boot chiplet 551 may include or perform a hardware stage 652 that prepares non-self-boot chiplet 551 to receive chiplet-stage boot code from self-boot chiplet 501. The security policy of the SiP may permit upstream authentication, trusted boot-channel delivery, or omission of local secure boot by the non-self-boot chiplet. BL-SIP code 514 of self-boot chiplet 501, along with BL-CPL code 563 and BL-SIP code 564 of non-self-boot chiplet 551 may be bundled together and signed with the SiP integrator’s private key. Within this bundle, BL-CPL code 563 may not be signed by any private key.

Hardware stage 652 may use reset-state hardware, boot-control logic, a boot-channel endpoint, a register block, a state machine, a sequencer, or other circuitry that is available before non-self-boot chiplet 551 executes BL-CPL code 563. Hardware stage 652 may be configured to perform limited early boot functions, such as receiving reset release from self-boot chiplet 501, enabling a Boot Channel endpoint, exposing boot-status information, accepting boot-loader address or size information, receiving BL-CPL code 563, and indicating readiness to self-boot chiplet 501. Unlike BL-ROM stage 552 of FIG. 5, hardware stage 652 may not execute immutable boot ROM code and may not verify BL-CPL code 563 using a chiplet-designer public key before BL-CPL code 563 begins execution.

In boot flow 600, non-self-boot chiplet 551 may rely on an upstream self-boot chiplet 501, a trusted Boot Channel, a package-level security policy, or prior verification by self-boot chiplet 501 for authentication of boot information. For example, self-boot chiplet 501 may verify a SiP-integrator-signed boot bundle before distributing boot components to non-self-boot chiplet 551. In such an embodiment, non-self-boot chiplet 551 may omit local verification of one or more received boot components, thereby reducing local boot complexity, reducing hardware requirements, or shortening boot latency for non-self-boot chiplet 551.

In boot flow 600, the self-boot side may operate as described above with respect to boot flow 500. For example, self-boot chiplet 501 may execute BL-ROM stage 502, BL-CPL stage 503, and BL-SIP stage 504. BL-ROM stage 502 may load or verify BL-CPL code 513, BL-CPL stage 503 may perform chiplet-local initialization for self-boot chiplet 501 and may load or verify boot components for the SiP boot flow, and BL-SIP stage 504 may coordinate boot of one or more downstream non-self-boot chiplets over an always-available Boot Channel.

After self-boot chiplet 501 is ready to coordinate boot of non-self-boot chiplet 551, at step 531, BL-SIP stage 504 may release non-self-boot chiplet 551 from reset or otherwise initiate early boot of non-self-boot chiplet 551. In response, hardware stage 652 of non-self-boot chiplet 551 may enter a state in which it is ready to accept BL-CPL code 563 from self-boot chiplet 501. At step 532, hardware stage 652 may communicate this readiness over the Boot Channel using a boot-status register, a ready indication, a boot-channel message, or another boot transaction.

At step 533, self-boot chiplet 501 may transfer BL-CPL code 563 to non-self-boot chiplet 551 over the Boot Channel. Because hardware stage 652 does not perform the BL-ROM verification operation described for boot flow 500, non-self-boot chiplet 551 may begin execution of BL-CPL code 563 after the BL-CPL transfer is completed and any required boot-control command is received. BL-CPL stage 553 may then perform chiplet-local initialization for non-self-boot chiplet 551, including configuring local circuitry, local fabric, memory resources, security state, reset domains, clocks, subsystem-specific settings, or other chiplet-level resources.

After completing sufficient chiplet-local initialization, BL-CPL stage 553 may configure non-self-boot chiplet 551 to receive BL-SIP code 564 from self-boot chiplet 501. At step 534, non-self-boot chiplet 551 may indicate over the Boot Channel that it is ready to accept BL-SIP code 564. At step 535, self-boot chiplet 501 may transfer BL-SIP code 564 over the Boot Channel and may indicate that the BL-SIP transfer is complete.

Unlike the secure-boot flow of FIG. 5, BL-CPL stage 553 in FIG. 6 may not verify BL-SIP code 564 using a SiP-integrator public key before allowing BL-SIP code 564 to execute. Instead, when BL-SIP code 564 is received, BL-CPL stage 553 may jump to BL-SIP stage 554. The jump may include branching to an entry point of BL-SIP code 564, updating a boot-control register, setting a boot-status indication, transferring execution control to a processor or sequencer executing BL-SIP code 564, or otherwise causing non-self-boot chiplet 551 to begin the SiP boot stage.

BL-SIP stage 554 may then perform SiP-stage operations for non-self-boot chiplet 551. For example, BL-SIP stage 554 may configure package-level settings, update local configuration based on SiP configuration data, prepare non-self-boot chiplet 551 for inter-chiplet communication, indicate readiness for data-plane enablement, or participate in later package-level bring-up. Self-boot chiplet 501 may coordinate these operations over the Boot Channel and may initiate a later bring-up operation, such as enabling a data-plane channel or initializing an inter-chiplet communication resource. For example, at step 536, non-self-boot chiplet 551 may indicate a readiness for training a data-plane channel and, at step 537, self-boot chiplet 501 may initiate training the data-plane channel.

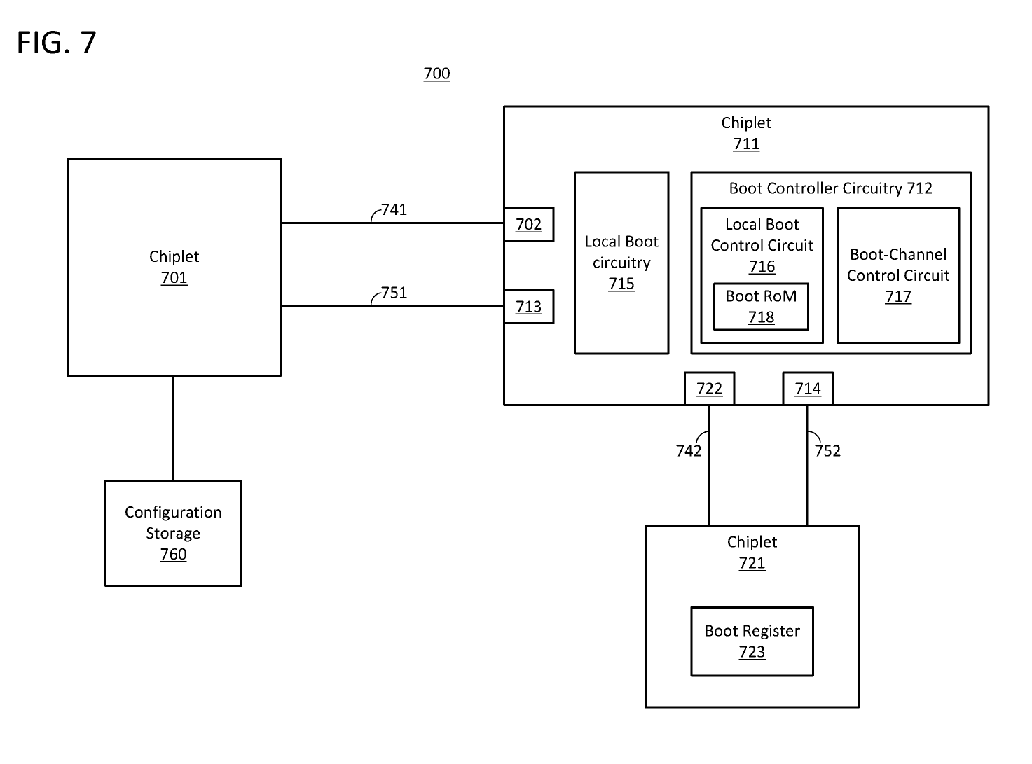

FIG. 7 illustrates an example of network 700 of chiplets in accordance with specific embodiments of the inventions disclosed herein. Network 700 may be a SiP. Network 700 may include chiplet 701, chiplet 711, and chiplet 721. Boot-channel connections may be enabled before respective data-plane channels are enabled. Data-plane channels may be high-speed die-to-die channels. Chiplet 701 may be configured as a self-boot boot-primary chiplet. Chiplet 711 may be configured as a self-boot boot-secondary chiplet downstream of chiplet 701 and upstream of chiplet 721 in a hierarchical boot topology of network 700. Chiplet 701 may be configured to initiate a chiplet boot stage of the chiplet 711. Chiplet 721 may be a second boot-secondary chiplet downstream of chiplet 711 in the boot topology of network 700. Configuration storage 760 may store package configuration data identifying the boot topology of network 700. Network 700 is an example, and a network of chiplets or SiP may include any quantity of chiplets connected in a variety of topologies.

Data-plane channel 741 between chiplet 701 and chiplet 711 may be configured to carry data-plane traffic between chiplet 701 and chiplet 711 when it is enabled. Boot-channel connection 751 between chiplet 701 and chiplet 711 may be distinct from data-plane channel 741. Boot-channel connection 751 may be configured to, upon supply of power and clock to chiplet 701 and chiplet 711, support communication of boot transactions from chiplet 701 to chiplet 711 before data-plane channel 741 is trained or enabled to carry data-plane traffic.

Boot-channel connection 751 may be configured to enter a default operational state upon supply of power and clock to chiplet 701 and chiplet 711. The default operational state may permit chiplet 701 to send a first boot transaction to chiplet 711 over boot-channel connection 751 without first sending a configuration transaction over the boot-channel connection 751 to enable the boot-channel connection. Upstream boot-channel interface 713 (connected to boot-channel connection 751) and downstream boot-channel interface 714 (connected to boot-channel connection 752) may each be configured to be ready for use upon supply of power and clock to the chiplet 711.

Boot-channel connection 751 may be configured to support authenticated boot transactions before the data-plane channel 741 is enabled. The authenticated boot transactions may include an authenticated write to a boot-control register, an authenticated transfer of a boot image, an authenticated read of boot-status information, or a combination thereof.

Chiplet 701 may be configured to use boot-channel connection 751 to coordinate a boot flow of chiplet 711. Upstream boot-channel interface 713 may be configured to communicate with upstream self-boot chiplet 701. The boot flow may include a chiplet boot stage in which chiplet 711 performs local configuration of circuitry of chiplet 711. The boot flow may also include a SiP boot stage or network boot stage, after the chiplet boot stage, in which package-level configuration is performed and data-plane channel 741 is enabled. Boot transactions communicated over boot-channel connection 751 before data-plane channel 741 is enabled may include a command to start the chiplet boot stage, a transfer of chiplet-stage boot code, a command to start the SiP boot stage, status information indicating readiness of the second chiplet to proceed from the chiplet boot stage to the SiP boot stage, or a combination thereof.

Chiplet 711 may include boot controller circuitry 712. In specific embodiments, boot controller circuitry 712 may be configured to perform the chiplet boot stage for chiplet 711 and communicate first boot information with the chiplet 701 over the boot-channel connection 751. First boot information may include boot synchronization, boot-status reporting, etc. In specific embodiments, after the chiplet boot stage of chiplet 711, boot controller circuitry 712 may be configured to perform a SiP boot stage comprising package-level configuration. The SiP boot stage may include enabling data-plane channel 741 and other data-plane channels of network 700 of chiplets to carry data-plane traffic. Boot-channel connection 751 may continue to support communication of boot transactions after the data-plane channel 741 is enabled.

Chiplet 711 may be configured for use as an intermediate boot node in the hierarchical boot topology of network 700. In specific embodiments, network 700 may include data-plane channel 742 between chiplet 711 and chiplet 721. Network 700 may also include boot-channel connection 752 between chiplet 711 and chiplet 721. Boot-channel connection 752 may be distinct from data-plane channel 742. Boot-channel connection 752 may be configured to, upon supply of power and clock to chiplet 711 and chiplet 721, support communication of boot transactions from chiplet 711 to chiplet 721 before data-plane channel 742 is trained or enabled. Downstream boot-channel interface 714 may be configured to communicate with downstream chiplet 721.

Chiplet 711 may include data-plane interface 702 configured to communicate data-plane traffic with chiplet 701 and data-plane interface 722 configured to communicate data-plane traffic with chiplet 711. Boot controller circuitry 712 may be configured to communicate through upstream boot-channel interface 713 or downstream boot-channel interface 714 before the data-plane interfaces 702 and 722 are enabled to carry data-plane traffic. In specific embodiments, the data-plane interfaces may comprise high-speed die-to-die interfaces. The data-plane interfaces may be enabled to carry the data-plane traffic after link initialization of the respective high-speed die-to-die interfaces. Boot controller circuitry 712 may be configured to, after data-plane interface 722 is enabled to carry the data-plane traffic, remap at least a portion of boot-channel communication from the downstream boot-channel interface 714 to data-plane interface 722.

Boot controller circuitry 712 may be coupled to local boot circuitry 715, upstream boot-channel interface 713, and downstream boot-channel interface 714. Boot controller circuitry 712 may include at least one local boot control circuit 716 configured to control the chiplet boot stage of chiplet 711 and at least one boot-channel control circuit 717 configured to control communication through upstream boot-channel interface 713, downstream boot-channel interface 714, or both. Local boot control circuit 716 may include boot read-only memory 718 configured to execute initial boot code for chiplet 711.

During a first portion of a boot process, boot controller circuitry 712 may be configured to operate chiplet 711 as a boot-secondary chiplet with respect to upstream self-boot chiplet 701 and to perform the chiplet boot stage of chiplet 711 using local boot circuitry 715. Local boot circuitry 715 may be configured to perform a chiplet boot stage of chiplet 711. The initial boot code may be configured to load or verify a chiplet-stage boot loader before chiplet 711 operates as the upstream self-boot chiplet with respect to downstream chiplet 721. After the chiplet boot stage of chiplet 711, boot controller circuitry 712 may be configured to operate chiplet 711 as an upstream self-boot chiplet with respect to downstream chiplet 721.

Boot controller circuitry 712 may be configured to select, based on a security policy received through the upstream boot-channel interface 713 between a first mode in which chiplet 711 authenticates boot information on behalf of the downstream chiplet 721 and a second mode in which the downstream chiplet 721 locally authenticates the boot information before execution.

Boot controller circuitry 712 may be configured to initiate a chiplet boot stage of the chiplet 721 through downstream boot-channel interface 714 and over boot-channel connection 752. Initiating the chiplet boot stage of the downstream chiplet 721 may include performing a boot handshake over the downstream boot-channel interface. The boot handshake may include releasing downstream chiplet 721 from reset, receiving an indication that downstream chiplet 721 is ready to accept a chiplet-stage boot image, receiving an indication that transfer of the chiplet-stage boot image is complete, receiving an indication that downstream chiplet 721 is ready to accept a SiP-stage boot image, or receiving an indication that downstream chiplet 721 is ready to proceed to a later boot stage.

After initiating the chiplet boot stage of chiplet 721, boot controller circuitry 712 may be configured to transfer second boot information to chiplet 721 through downstream boot-channel interface 714 and over boot-channel connection 752. Second boot information may include a chiplet-stage boot image, a system-in-package-stage boot image, a boot-loader address, a boot-loader size, a boot-control command, etc. In specific embodiments, boot controller circuitry 712 may be configured to receive boot status information from chiplet 721 over boot-channel connection 752 and through downstream boot-channel interface 714. Boot controller circuitry may be configured to forward boot status information toward chiplet 701 over boot-channel connection 751 and through upstream boot-channel interface 713. In specific embodiments, a chiplet-stage boot image may be verified using a key associated with a chiplet designer and a SiP-stage boot image may be verified using a key associated with a SiP integrator.

In specific embodiments, chiplet 711 may be configured to access, over boot-channel connection 752, one or more boot registers 723 of chiplet 721. Chiplet 711 may be configured to aggregate boot status information for chiplet 721 with boot status information for chiplet 711 and to report the aggregated boot status information toward chiplet 701 over boot-channel connection 751. Boot controller circuitry 712 may be configured to generate a boot report comprising a first boot status of chiplet 711 and a second boot status received from downstream chiplet 721, and to make the boot report available to the upstream self-boot chiplet 701 through upstream boot-channel interface 713.

Downstream chiplets in the boot topology may use the Boot Channel to report their boot status to upstream chiplets, with all reports ultimately aggregated by the boot primary chiplet. The boot primary chiplet may further forward these reports to a board-level controller, such as a board management controller (BMC), through implementation-defined interfaces. When a boot report is required, it may be stored in the downstream chiplets and made available to the immediate upstream self-boot chiplet. A boot secondary chiplet may use the Boot Channel to notify its immediate upstream self-boot chiplet when a boot report is available. The upstream self-boot chiplet may retrieve boot reports via the Boot Channel. If it is not the boot primary chiplet, it may notify its immediate upstream self-boot chiplet through the Boot Channel. Location of the report may be provided as device configuration information.

Although FIG. 7 illustrates certain boot-related circuitry in chiplet 711, corresponding circuitry may be included in one or more other chiplets of the system-in-package and is omitted from those other chiplets for clarity of illustration. For example, any chiplet shown in FIG. 7 may include local boot circuitry, boot and security circuitry, boot-channel interface circuitry, boot-control circuitry, boot-status circuitry, boot registers, local boot-code storage, secure-boot circuitry, or other circuitry used to participate in the boot flows described herein. Thus, the depiction of such circuitry in chiplet 711 should not be understood as limiting the boot architecture to a single chiplet having those resources. Rather, chiplet 711 is shown as a representative example of a chiplet that can participate in a hierarchical boot topology, and other chiplets may include the same, similar, additional, or fewer boot-related resources depending on whether the chiplet is configured as a boot-primary chiplet, a self-boot boot-secondary chiplet, a non-self-boot chiplet, an intermediate boot node, or a leaf chiplet in the boot topology.

In some embodiments, multiple boot-secondary chiplets may be self-boot chiplets. A self-boot boot-secondary chiplet may perform its own chiplet boot stage and may thereafter assist in booting one or more downstream chiplets. For example, a boot-primary chiplet may be directly connected to multiple self-boot boot-secondary chiplets, each of which is responsible for a different downstream portion of the system-in-package. In such an arrangement, the boot-primary chiplet may initiate or synchronize boot of the self-boot boot-secondary chiplets, and each self-boot boot-secondary chiplet may then use a corresponding downstream Boot Channel to initiate boot of one or more additional chiplets. Boot status from the downstream chiplets may be reported to the corresponding self-boot boot-secondary chiplet and then forwarded or aggregated toward the boot-primary chiplet.

In other embodiments, self-boot boot-secondary chiplets may be connected together in a chain or multi-level hierarchy. For example, a boot-primary chiplet may be upstream of a first self-boot boot-secondary chiplet, the first self-boot boot-secondary chiplet may be upstream of a second self-boot boot-secondary chiplet, and the second self-boot boot-secondary chiplet may be upstream of one or more additional downstream chiplets. Each intermediate self-boot boot-secondary chiplet in the chain may operate as a boot-secondary chiplet with respect to its upstream chiplet during an earlier portion of boot and, after completing its own chiplet boot stage, may operate as an upstream self-boot chiplet with respect to its downstream chiplet or downstream subtree. In this manner, boot responsibility may be distributed across multiple levels of the boot topology rather than being centralized in the boot-primary chiplet.

The chiplet topology may be implemented as a flat topology, a hierarchical topology, a chained topology, a branching topology, or a combination thereof. In a flat topology, the boot-primary chiplet may directly coordinate boot of multiple boot-secondary chiplets. In a hierarchical or branching topology, one or more self-boot boot-secondary chiplets may serve as intermediate boot nodes for downstream chiplets. In a chained topology, multiple self-boot boot-secondary chiplets may be arranged serially such that boot control, boot-image transfer, boot-stage synchronization, and boot-status reporting proceed through successive upstream and downstream relationships. The particular topology may be identified by package configuration data, boot topology data, straps, fuses, firmware-visible data structures, or other configuration information provided for the system-in-package.

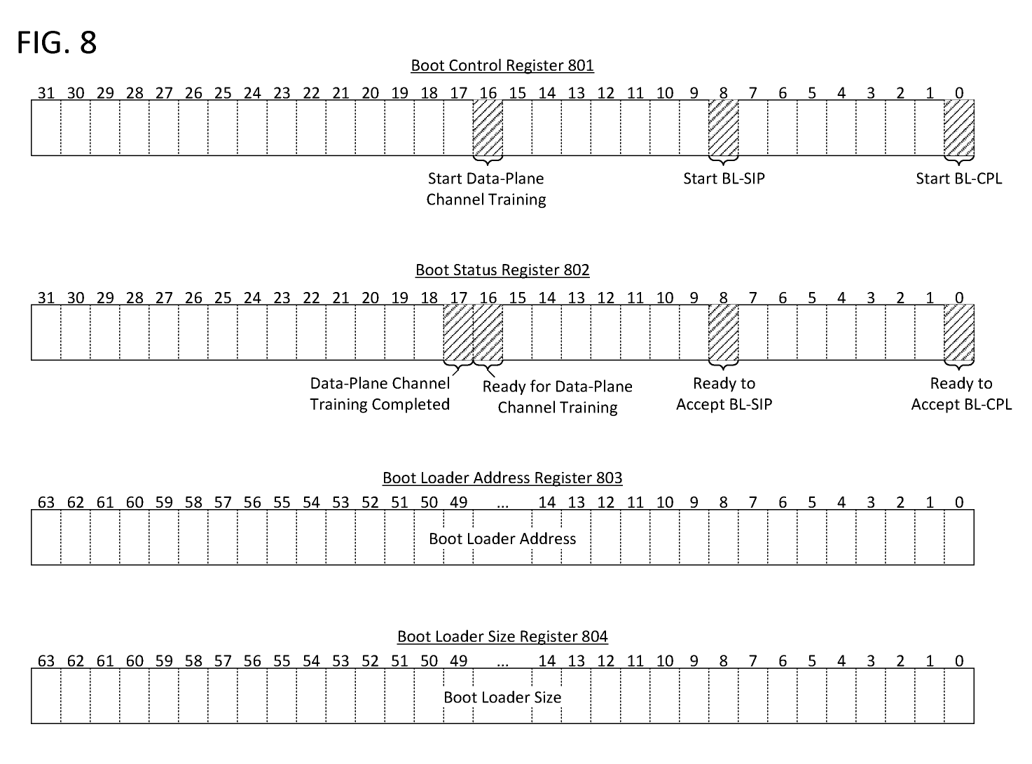

FIG. 8 illustrates example boot registers that may be implemented by a boot-secondary chiplet in accordance with specific embodiments of the inventions disclosed herein. The boot registers may be accessible to an upstream self-boot chiplet through a Boot Channel. The boot registers may provide a mechanism for an upstream chiplet to coordinate boot of a downstream chiplet, including starting boot stages, identifying boot-loader information, determining readiness of the downstream chiplet, and coordinating later package-level bring-up operations. In this manner, the upstream chiplet may orchestrate boot of the downstream chiplet using the Boot Channel before a data-plane channel is enabled for ordinary operational traffic.

In the illustrated embodiment, the set of boot registers include boot control register 801, boot status register 802, boot loader address register 803, and boot loader size register 804. The boot registers may be located at a base address associated with boot setup or chiplet setup information for the downstream chiplet. In some embodiments, configuration data provided by a system-in-package integrator identifies the base address or other access mechanism for the boot registers. The local base address of these registers may be provided as device configuration information. Although FIG. 8 illustrates a register-based implementation, similar boot control and status information may be implemented using memory-mapped registers, control/status registers, mailbox registers, messages, packets, sideband signals, firmware-visible data structures, or other Boot Channel-accessible resources.

Boot control register 801 may include one or more control fields that allow an upstream self-boot chiplet to command a downstream chiplet to begin or advance through one or more boot operations. For example, boot control register 801 may include a field that instructs the downstream chiplet to start a BL-CPL stage, a field that instructs the downstream chiplet to start a BL-SIP stage, and a field that instructs the downstream chiplet to start a later package-level bring-up operation. In embodiments that include a high-speed die-to-die interface, the later package-level bring-up operation may include link initialization or training of the high-speed die-to-die interface. More generally, the later package-level bring-up operation may include enabling a data-plane channel or preparing the downstream chiplet to participate in data-plane communication.

In some embodiments, a start-BL-CPL field (e.g., bit 0) of boot control register 801 is used by the upstream self-boot chiplet to notify a non-self-boot downstream chiplet to begin executing BL-CPL code that has been transferred or otherwise made available to the downstream chiplet. In some embodiments, the same or a similar field may be used to notify a self-boot downstream chiplet to load, verify, or execute its own chiplet-stage boot code. A start-BL-SIP field (e.g., bit 8) may be used to notify a non-self-boot downstream chiplet to begin executing BL-SIP code. For a self-boot downstream chiplet, the start-BL-SIP field may be ignored, may be handled differently, or may be unnecessary because the self-boot downstream chiplet may automatically transition from chiplet-stage boot to SiP-stage boot according to its local boot flow. In specific embodiments, a start-data-plane-channel-training field (e.g., bit 16) may notify the secondary chiplet to start training the data-plane channel. If the data plane channel is a D2D channel, then the training may be D2D training.

Boot status register 802 may include one or more status fields that allow the downstream chiplet to report boot readiness or boot progress to the upstream self-boot chiplet. For example, boot status register 802 may include a field (e.g., bit 0) indicating that the downstream chiplet is ready to accept BL-CPL code, a field (e.g., bit 8) indicating that the downstream chiplet is ready to accept BL-SIP code, a field (e.g., bit 16) indicating that the downstream chiplet is ready for a later package-level bring-up operation, and a field (e.g., bit 17) indicating that the later package-level bring-up operation has completed. The fields may indicate readiness for data-plane enablement and completion of data-plane enablement. In embodiments that include a high-speed die-to-die interface, the readiness and completion fields may indicate readiness for die-to-die link training and completion of die-to-die link training.

Boot status register 802 may be used by the upstream self-boot chiplet to determine when to advance the downstream chiplet from one boot phase to another. For example, the upstream self-boot chiplet may poll boot status register 802, receive a notification associated with boot status register 802, or otherwise access status information over the Boot Channel. After boot status register 802 indicates that the downstream chiplet is ready to accept BL-CPL code, the upstream self-boot chiplet may transfer BL-CPL code or related boot information to the downstream chiplet. After boot status register 802 indicates that the downstream chiplet is ready to accept BL-SIP code, the upstream self-boot chiplet may transfer BL-SIP code or related boot information. The field indicating that the downstream chiplet is ready to accept BL-SIP code may not be applicable to self-boot secondary chiplets that automatically jumps from BL-CPL to BL-SIP. After boot status register 802 indicates readiness for package-level bring-up, the upstream self-boot chiplet may coordinate data-plane enablement, link initialization, or another SiP-stage operation.

Boot loader address register 803 may store an address associated with boot code or boot information for the downstream chiplet. In some embodiments, boot loader address register 803 stores a boot-loader start address in the local address view of the downstream chiplet. The address may identify a location in local memory, SRAM, a boot buffer, a mapped region, or another storage location from which the downstream chiplet is to read or execute received boot code. For example, after BL-CPL code or BL-SIP code is transferred to the downstream chiplet over the Boot Channel, boot loader address register 803 may identify the start address of the received boot code. The non-self-boot secondary chiplet may first check boot control register 801 to confirm that a boot loader has been received, then may read from boot loader address register 803 to tell where it is. This may not be applicable to self-boot secondary chiplets.

Boot loader size register 804 may store a size associated with boot code or boot information for the downstream chiplet. In some embodiments, boot loader size register 804 may store a quantity of bytes of the boot-loader image, boot-code image, or other boot information identified by boot loader address register 803. The downstream chiplet may use boot loader address register 803 and boot loader size register 804 together to determine the location and extent of a received boot image before verifying, loading, executing, or otherwise processing the boot image. The secondary chiplet may first check boot control register 801 to confirm a boot loader has been received, then may read from boot loader size register 804 to tell how large it is.

In one example boot sequence, an upstream self-boot chiplet may access boot status register 802 over the Boot Channel to determine that a downstream chiplet is ready to accept chiplet-stage boot code. The upstream self-boot chiplet may then transfer the chiplet-stage boot code to the downstream chiplet, write boot loader address register 803 with a start address of the transferred code, write boot loader size register 804 with the size of the transferred code, and write boot control register 801 to instruct the downstream chiplet to start the BL-CPL stage. The downstream chiplet may then execute, verify, or otherwise process the chiplet-stage boot code and update boot status register 802 to indicate readiness for a later stage.

In a further portion of the boot sequence, the upstream self-boot chiplet may determine from boot status register 802 that the downstream chiplet is ready to accept SiP-stage boot code. The upstream self-boot chiplet may transfer the SiP-stage boot code to the downstream chiplet, update boot loader address register 803 and boot loader size register 804 to identify the SiP-stage boot code, and write boot control register 801 to instruct the downstream chiplet to start the BL-SIP stage. The downstream chiplet may then perform SiP-stage operations, such as updating package-level configuration, preparing for inter-chiplet communication, or preparing for data-plane enablement.

The boot registers may also support hierarchical boot status reporting. For example, in a hierarchical boot topology, an intermediate chiplet may access the boot registers of a downstream chiplet over a downstream Boot Channel, determine boot status of that downstream chiplet, and then forward or aggregate that boot status toward a boot-primary chiplet over an upstream Boot Channel. Thus, the boot registers may be used not only for direct boot control by a boot-primary chiplet, but also for delegated boot control by a self-boot boot-secondary chiplet acting as an upstream boot agent for another downstream chiplet.

In some embodiments, the boot registers shown in FIG. 8 may be located using offsets from a chiplet setup base address. As used herein, the chiplet setup base address may refer to a base address of a chiplet setup register block for a particular chiplet. For example, boot control register 801 may have an offset of 0x0 from the chiplet setup base address and may thus be located at the chiplet setup base address. Boot status register 802 may have an offset of 0x4 such that it may be located at the chiplet setup base address plus four bytes. Similarly, boot loader address register 803 and boot loader size register 804 may be located at their respective offsets (e.g., 0x8 and 0x10 respectively). This offset-based arrangement allows different chiplets to implement a common boot-register layout while using different base addresses for their respective chiplet setup register blocks. An upstream self-boot chiplet may access the boot registers of a downstream chiplet over the Boot Channel by using the downstream chiplet’s setup base address and the corresponding register offsets.

The register names, bit positions, field widths, offsets, and field definitions shown in FIG. 8 are examples. Other embodiments may include additional registers, fewer registers, different register widths, different field positions, different access attributes, or different encodings. Reserved fields may be preserved on reads or writes, ignored, hardwired, or used for future expansion. The boot registers may be implemented in hardware, firmware, microcode, a register file, a mailbox, a memory-mapped region, or any other structure accessible through the Boot Channel.

In some embodiments, boot loader read-only memory (BL-ROM) determines one or more boot paths for the chiplet, such as secure or insecure boot, primary or secondary boot, self-boot or non-self-boot operation, regular boot, recovery boot, factory boot, or other boot modes. BL-ROM may load, authenticate, verify, measure, or otherwise validate subsequent chiplet-stage boot code, such as BL-CPL, before allowing that subsequent boot code to execute. In a non-self-boot chiplet, BL-ROM may also configure the chiplet to receive chiplet-stage boot code from an upstream self-boot chiplet over a Boot Channel.

Boot loader chiplet (BL-CPL) may perform chiplet-local initialization, including one or more of configuring local power, reset, clocking, phase-locked loops, local fabric, local memory, subsystem-specific settings, security state, lifecycle state, access-control settings, feature-enablement settings, performance settings, or debug restrictions. BL-CPL may also enforce chiplet-designer policies or protections, including intellectual-property-protection settings. In some embodiments, BL-CPL is developed, supplied, signed, authenticated, or controlled by a chiplet designer. BL-CPL may be optional, and a chiplet may omit BL-CPL when BL-ROM or another boot component performs the corresponding chiplet-stage boot functions.

Boot loader system-in-package (BL-SIP) may perform operations that depend on the final system-in-package configuration, such as updating chiplet configuration, coordinating multiple chiplets, configuring package-level address maps, configuring fabric routing, configuring address remapping, applying package-level security policy, enabling data-plane channels, initializing or training inter-chiplet communication resources, distributing boot information to downstream chiplets, and loading later software stages. In some embodiments, BL-SIP is developed, supplied, signed, authenticated, or controlled by a system-in-package integrator.

The disclosed boot architecture may improve operation of a chiplet-based system-in-package by allowing boot to begin before ordinary data-plane communication paths are enabled, distributing boot responsibility across a hierarchical topology of chiplets, and separating chiplet-local initialization from package-level initialization. An always-available Boot Channel may permit early boot transactions, such as reset release, boot-image transfer, boot-control commands, readiness indications, boot-status reporting, and security-related transactions, even when a data-plane channel is not yet available. By allowing an intermediate chiplet to first complete its own chiplet boot stage and then act as an upstream self-boot chiplet for downstream chiplets, the architecture may reduce reliance on a single centralized boot chiplet, improve scalability for larger chiplet networks, simplify boot routing in hierarchical package topologies, and allow boot status to be aggregated and reported through the boot hierarchy. The multi-stage boot structure may further support separation of chiplet-designer-controlled boot operations from system-in-package-integrator-controlled boot operations, thereby improving flexibility, security, and reuse of chiplets across different package configurations.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Although examples in the disclosure were generally directed to chiplets integrated in a system-in-package, any multi-die, multi-chip, multi-chiplet, interposer-based, 2.5D, 3D-stacked, module-level, or other integrated electronic system having multiple interconnected components may be used. Similarly, although boot-channel connections implemented using low-speed die-to-die interfaces are generally discussed, a Boot Channel may be implemented using any out-of-band, sideband, low-speed, dedicated, shared, physical, transport, protocol, or other communication resource that supports boot transactions before a data-plane channel is enabled. These and other modifications and variations to the present invention may be practiced by those skilled in the art, without departing from the scope of the present invention, which is more particularly set forth in the appended claims.

What is claimed is:

1. A system-in-package comprising:
a first chiplet;
a second chiplet;
a data-plane channel between the first chiplet and the second chiplet, the data-plane channel configured to carry data-plane traffic between the first chiplet and the second chiplet when the data-plane channel is enabled; and
a boot-channel connection between the first chiplet and the second chiplet, the boot-channel connection being distinct from the data-plane channel;
wherein the boot-channel connection is configured to, upon supply of power and clock to the first chiplet and the second chiplet, support communication of boot transactions from the first chiplet to the second chiplet before the data-plane channel is enabled to carry the data-plane traffic.

2. The system-in-package of claim 1 wherein the boot-channel connection continues to support communication of boot transactions after the data-plane channel is enabled.

3. The system-in-package of claim 1, wherein the boot-channel connection is configured to enter a default operational state upon supply of power and clock to the first chiplet and the second chiplet, the default operational state permitting the first chiplet to send a first boot transaction to the second chiplet over the boot-channel connection without first sending a configuration transaction over the boot-channel connection to enable the boot-channel connection.

4. The system-in-package of claim 1, further comprising:
a third chiplet;
a second data-plane channel between the second chiplet and the third chiplet; and
a second boot-channel connection between the second chiplet and the third chiplet, the second boot-channel connection being distinct from the second data-plane channel;
wherein the first chiplet is configured as a boot-primary chiplet;
wherein the second chiplet is configured as a self-boot boot-secondary chiplet downstream of the first chiplet and upstream of the third chiplet in a hierarchical boot topology of the system-in-package; and
wherein the second boot-channel connection is configured to, upon supply of power and clock to the second chiplet and the third chiplet, support communication of boot transactions from the second chiplet to the third chiplet before the second data-plane channel is enabled.

5. The system-in-package of claim 1, wherein the first chiplet is configured to use the boot-channel connection to coordinate a boot flow of the second chiplet comprising:
a chiplet boot stage in which the second chiplet performs local configuration of circuitry of the second chiplet; and
a system-in-package boot stage, after the chiplet boot stage, in which package-level configuration is performed and the data-plane channel is enabled,
wherein boot transactions communicated over the boot-channel connection before the data-plane channel is enabled comprise at least one of: a command to start the chiplet boot stage, a transfer of chiplet-stage boot code, a command to start the system-in-package boot stage, and status information indicating readiness of the second chiplet to proceed from the chiplet boot stage to the system-in-package boot stage.

6. The system-in-package of claim 1, wherein:
the boot-channel connection is configured to support authenticated boot transactions before the data-plane channel is enabled; and
the authenticated boot transactions comprise at least one of an authenticated write to a boot-control register, an authenticated transfer of a boot image, or an authenticated read of boot-status information.

7. The system-in-package of claim 1, wherein the data-plane channel is a high-speed die-to-die channel.

8. A network of chiplets comprising:
a boot-primary chiplet;
a first boot-secondary chiplet, wherein the boot-primary chiplet is configured to initiate a chiplet boot stage of the first boot-secondary chiplet;
a second boot-secondary chiplet downstream of the first boot-secondary chiplet in a boot topology of the network of chiplets;
a first boot-channel connection between the boot-primary chiplet and the first boot-secondary chiplet; and
a second boot-channel connection between the first boot-secondary chiplet and the second boot-secondary chiplet;
wherein the first boot-secondary chiplet comprises boot controller circuitry configured to:
perform the chiplet boot stage for the first boot-secondary chiplet;
communicate first boot information with the boot-primary chiplet over the first boot-channel connection;
initiate a chiplet boot stage of the second boot-secondary chiplet over the second boot-channel connection; and
transfer, after initiating the chiplet boot stage of the second boot-secondary chiplet, second boot information to the second boot-secondary chiplet over the second boot-channel connection.

9. The network of chiplets of claim 8, wherein the first boot-channel connection and the second boot-channel connection are configured to be operational upon supply of power and clock to the boot-primary chiplet, the first boot-secondary chiplet, and the second boot-secondary chiplet and before an initialization of a data-plane channel connecting the first boot-secondary chiplet and the second boot-secondary chiplet.

10. The network of chiplets of claim 8, wherein the boot controller circuitry is further configured to:
receive boot status information from the second boot-secondary chiplet over the second boot-channel connection; and
forward boot status information toward the boot-primary chiplet over the first boot-channel connection.

11. The network of chiplets of claim 8, further comprising configuration storage storing package configuration data identifying the boot topology of the network of chiplets.

12. The network of chiplets of claim 8, wherein the first boot information comprises at least one of: boot synchronization and boot-status reporting.

13. The network of chiplets of claim 8, wherein the second boot information comprises at least one of: a chiplet-stage boot image, a system-in-package-stage boot image, a boot-loader address, a boot-loader size, and a boot-control command.

14. The network of chiplets of claim 8, wherein the boot controller circuitry is configured to perform, after the chiplet boot stage of the first boot-secondary chiplet, a system-in-package boot stage comprising package-level configuration.

15. The network of chiplets of claim 14, wherein the system-in-package boot stage comprises enabling one or more data-plane channels of the network of chiplets to carry data-plane traffic.

16. The network of chiplets of claim 14, wherein a chiplet-stage boot image is verified using a key associated with a chiplet designer and a system-in-package-stage boot image is verified using a key associated with a system-in-package integrator.

17. The network of chiplets of claim 8, wherein the first boot-secondary chiplet is configured to access, over the second boot-channel connection, one or more boot registers of the second boot-secondary chiplet.

18. The network of chiplets of claim 8, wherein the first boot-secondary chiplet is configured to aggregate boot status information for the second boot-secondary chiplet with boot status information for the first boot-secondary chiplet and to report the aggregated boot status information toward the boot-primary chiplet over the first boot-channel connection.

19. A chiplet configured for use as an intermediate boot node in a hierarchical boot topology of a system-in-package, the chiplet comprising:
local boot circuitry configured to perform a chiplet boot stage of the chiplet;
an upstream boot-channel interface configured to communicate with an upstream self-boot chiplet;
a downstream boot-channel interface configured to communicate with a downstream chiplet; and
boot controller circuitry coupled to the local boot circuitry, the upstream boot-channel interface, and the downstream boot-channel interface;
wherein the boot controller circuitry is configured to:
during a first portion of a boot process, operate the chiplet as a boot-secondary chiplet with respect to the upstream self-boot chiplet;
perform the chiplet boot stage of the chiplet using the local boot circuitry;
after the chiplet boot stage of the chiplet, operate the chiplet as an upstream self-boot chiplet with respect to the downstream chiplet;
initiate, through the downstream boot-channel interface, a chiplet boot stage of the downstream chiplet;
transfer, through the downstream boot-channel interface, boot information to the downstream chiplet;
receive, through the downstream boot-channel interface, boot status information from the downstream chiplet; and
forward, through the upstream boot-channel interface, the boot status information toward a boot-primary chiplet.

20. The chiplet of claim 19, wherein the upstream boot-channel interface and the downstream boot-channel interface are each configured to be ready for use upon supply of power and clock.

21. The chiplet of claim 19, wherein the boot controller circuitry is configured to generate a boot report comprising a first boot status of the chiplet and a second boot status received from the downstream chiplet, and to make the boot report available to the upstream self-boot chiplet through the upstream boot-channel interface.

22. The chiplet of claim 19, wherein the boot controller circuitry is configured to select, based on a security policy received through the upstream boot-channel interface, between a first mode in which the chiplet authenticates boot information on behalf of the downstream chiplet and a second mode in which the downstream chiplet locally authenticates the boot information before execution.

23. The chiplet of claim 19, wherein the boot controller circuitry comprises:
at least one local boot control circuit configured to control the chiplet boot stage of the chiplet; and
at least one boot-channel control circuit configured to control communication through the upstream boot-channel interface or the downstream boot-channel interface.

24. The chiplet of claim 19, wherein:
the local boot circuitry comprises boot read-only memory configured to execute initial boot code for the chiplet; and
the initial boot code is configured to load or verify a chiplet-stage boot loader before the chiplet operates as the upstream self-boot chiplet with respect to the downstream chiplet.

25. The chiplet of claim 19, wherein initiating the chiplet boot stage of the downstream chiplet comprises performing a boot handshake over the downstream boot-channel interface, the boot handshake comprising at least one of: releasing the downstream chiplet from reset, receiving an indication that the downstream chiplet is ready to accept a chiplet-stage boot image, receiving an indication that transfer of the chiplet-stage boot image is complete, receiving an indication that the downstream chiplet is ready to accept a system-in-package-stage boot image, or receiving an indication that the downstream chiplet is ready to proceed to a later boot stage.

26. The chiplet of claim 19, further comprising a data-plane interface configured to communicate data-plane traffic with at least one other chiplet, wherein the boot controller circuitry is configured to communicate through the upstream boot-channel interface or the downstream boot-channel interface before the data-plane interface is enabled to carry the data-plane traffic.

27. The chiplet of claim 26, wherein:
the data-plane interface comprises a high-speed die-to-die interface; and
the data-plane interface is enabled to carry the data-plane traffic after link initialization of the high-speed die-to-die interface.

28. The chiplet of claim 26, wherein the boot controller circuitry is configured to, after the data-plane interface is enabled to carry the data-plane traffic, remap at least a portion of boot-channel communication from the downstream boot-channel interface to the data-plane interface.
